(19) United States
(12) Patent Application Publication
(10) Pub. No.: US 2025/0232480 A1
(43) Pub. Date: Jul. 17, 2025

(54) V-DMC NORMAL ENCODING INTEGRATION IN V-DMC AND BASE MESH ENCODER

(71) Applicant: QUALCOMM Incorporated, San Diego, CA (US)

(72) Inventors: Anique Akhtar, San Diego, CA (US); Geert Van der Auwera, San Diego, CA (US); Reetu Hooda, San Diego, CA (US); Adarsh Krishnan Ramasubramonian, Irvine, CA (US); Marta Karczewicz, San Diego, CA (US)

(21) Appl. No.: 19/018,955

(22) Filed: Jan. 13, 2025

Related U.S. Application Data
(60) Provisional application No. 63/622,028, filed on Jan. 17, 2024.
(60) Provisional application No. 63/623,706, filed on Jan. 22, 2024.
(60) Provisional application No. 63/575,039, filed on Apr. 5, 2024.

(51) Int. Cl. G06T 9/00

(52) U.S. Cl. CPC G06T 9/001

(57) ABSTRACT

A device for processing mesh data receives a syntax element for a mesh indicating whether vertices of the mesh are to be predicted using multi-parallelogram prediction or cross product prediction; selects one of the multi-parallelogram prediction or the cross product prediction as a selected prediction process for the mesh based on the syntax element; in response to determining for a first vertex that a first set of already decoded normals are available, predicts a normal for the first vertex using the selected prediction process; in response to determining for a second vertex that a second set of already decoded normals are unavailable, predicts a normal for the second vertex using a delta prediction process; and outputs a decoded version of the mesh based on the normal for the first vertex and the normal for the second vertex.

This application claims the benefit of:
U.S. Provisional Patent Application No. 63/575,039, filed 5 Apr. 2024;
U.S. Provisional Patent Application No. 63/623,706, filed 22 Jan. 2024; and
U.S. Provisional Patent Application No. 63/622,028, filed 17 Jan. 2024, the entire content of each application being incorporated herein by reference.

### TECHNICAL FIELD

This disclosure relates to video-based coding of dynamic meshes.

### BACKGROUND

Meshes may be used to represent physical content of a 3-dimensional space. Meshes have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure describes techniques related to the integration of normals encoding in the video-based coding of dynamic meshes (V-DMC). According to the techniques of this disclosure, a V-DMC decoder may receive a syntax element for a mesh indicating one of multi-parallelogram prediction or cross-product prediction. The V-DMC decoder may then attempt to decode the normals for the vertices in the mesh using the signaled prediction process. For some vertices in the mesh, however, the other vertices needed for the prediction process may not exist or may not have been decoded yet. For such vertices, the V-DMC decoder may predict the normal using delta prediction. If neither of the other vertices needed for delta prediction available, then the V-DMC decoder may receive a full normal value in the bitstream rather than a difference value.

According to an example of this disclosure, a device for processing mesh data includes a memory; and processing circuitry coupled to the memory and configured to: receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; select one of the multi-parallelogram prediction or the cross product prediction as a selected prediction process for the mesh based on the syntax element; in response to determining for a first vertex that a first set of already decoded normals are available, predict a normal for the first vertex using the selected prediction process; in response to determining for a second vertex that a second set of already decoded normals are unavailable, predict a normal for the second vertex using a delta prediction process; and output a decoded version of the mesh based on the normal for the first vertex and the normal for the second vertex.

According to another example of this disclosure, a method of processing mesh data includes receiving a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; selecting one of the multi-parallelogram prediction or the cross product prediction as a selected prediction process for the mesh based on the syntax element; in response to determining for a first vertex that a first set of already decoded normals are available, predicting a normal for the first vertex using the selected prediction process; in response to determining for a second vertex that a second set of already decoded normals are unavailable, predicting a normal for the second vertex using a delta prediction process; and outputting a decoded version of the mesh based on the normal for the first vertex and the normal for the second vertex.

According to another example of this disclosure, a computer-readable storage medium stores instructions that, when executed, cause one or more processors to receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; select one of the multi-parallelogram prediction or the cross product prediction as a selected prediction process for the mesh based on the syntax element; in response to determining for a first vertex that a first set of already decoded normals are available, predict a normal for the first vertex using the selected prediction process; in response to determining for a second vertex that a second set of already decoded normals are unavailable, predict a normal for the second vertex using a delta prediction process; and output a decoded version of the mesh based on the normal for the first vertex and the normal for the second vertex.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a V-DMC encoder.

FIG. 3 shows an example implementation of a V-DMC decoder.

FIG. 4 shows an example implementation of an intra-mode encoder for V-DMC.

FIG. 5 shows an example implementation of an intra-mode decoder for V-DMC.

FIG. 6 shows an example implementation of a V-DMC decoder.

FIG. 7 shows an example implementation of a coding process for coding base mesh connectivity.

FIG. 8A shows an example implementations of a base mesh encoder.

FIG. 8B shows an example implementations of a base mesh decoder.

FIG. 9 shows an example implementation of a V-DMC decoder that performs normal decoding in a lossless mode.

FIG. 10 shows an example implementation of a V-DMC decoder that performs normal decoding in a lossy intra mode.

FIG. 11 shows an example implementation of a V-DMC decoder that performs normal decoding in a lossy inter mode.

FIG. 12 shows an example implementation of a V-DMC decoder that performs normal map decoding in a lossless mode.

FIG. 13 shows an example implementation of a V-DMC decoder that performs normal map decoding in a lossy intra mode.

FIG. 14 shows an example implementation of a V-DMC decoder that performs normal map decoding in a lossy inter mode.

FIG. 15 shows an example corner table representation.

FIGS. 16A-16C show examples of normal prediction.

FIG. 17 is a flowchart illustrating an example process for encoding a mesh.

FIG. 18 is a flowchart illustrating an example process for decoding a compressed bitstream of mesh data.

FIG. 19 is a flowchart illustrating an example process for decoding a compressed bitstream of mesh data.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

This disclosure describes techniques related to the integration of normals encoding in the video-based coding of dynamic meshes (V-DMC) technology that is being standardized in MPEG WG7 (3DGH). The disclosure particularly focuses on implementation of normals encoding in the base mesh encoder within the V-DMC Test Model v6.0 (TMM v6.0), ISO/IEC JTC 1/SC 29/WG 7, N733, October 2023, incorporated herein by reference. In V-DMC, the base mesh connectivity is encoded using an EdgeBreaker implementation, and the base mesh attributes can be encoded using residual encoding with attribute prediction. However, the V-DMC tool, as well as the base mesh encoder, does not support the encoding of Normals as an attribute. The techniques of this disclosure integrate the normal encoding in the V-DMC tool and propose the implementation of normal encoding in base mesh encoder. The techniques of this disclosure may allow for the encoding of normals in a base mesh encoder in a lossless manner efficiently, and with a smaller bitstream.

Normals are vectors (x, y, z) that are perpendicular to the surface of a mesh. Normals are used to determine the orientation of the surface and to apply shading. In 3D modeling, normals play a crucial role in creating realistic-looking objects by, for example, helping to define the shape of the object and how it interacts with light. Normals are also used in computer graphics to create smooth surfaces and to calculate the reflection of light. In addition, normals are used in video games to create realistic-looking environments and to improve the performance of the game. In summary, normals are an essential component of 3D modeling and computer graphics and are used in a wide range of applications, from video games to scientific simulations.

A V-DMC decoder may be configured to determine a normal for a vertex by determining a predicted normal for the vertex, receiving a difference value in an encoded bitstream, and determining the final normal value for the vertex to be equal to the predicted value plus the difference. The V-DMC decoder may be configured to perform different prediction processes depending on what nearby vertices have already been decoded.

When performing multi-parallelogram prediction, a V-DMC decoder predicts a normal value for a current vertex (c in the figure below) as being equal to a previous normal value (c.p) plus a next normal value (c.n) minus an opposite normal value (c.o). The V-DMC decoder may make a similar prediction for multiple triangles surrounding the current vertex and set the final prediction as the average of the predictions for the multiple triangles.

When performing cross-product prediction, a V-DMC decoder predicts a normal value for a current vertex (c) by determining a vector between a previous vertex (c.p) and a current vertex (c), determining another vector between the next (c.n) and current vertex (c), and obtains a cross product of these two vectors. In some examples, the V-DMC decoder may do this for all or some triangles surrounding the current vertex and determine the predicted normal value as an average.

When performing delta prediction, a V-DMC decoder predicts a normal value for a current vertex (c) based on an already decoded normal value of a single vertex (either c.p or c.n). The V-DMC decoder determines the actual normal value by receiving a difference value in the bitstream and adding the difference value to the predicted normal value. A V-DMC decoder may also implement other types of prediction.

According to the techniques of this disclosure, a V-DMC decoder may receive a syntax element for a mesh indicating one of multi-parallelogram prediction or cross-product prediction. The V-DMC decoder may then attempt to decode the normals for the vertices in the mesh using the signaled prediction process. For some vertices in the mesh, however, the other vertices needed for the prediction process may not exist or may not have been decoded yet. For such vertices, the V-DMC decoder may predict the normal using delta prediction. If neither of the other vertices needed for delta prediction available, then the V-DMC decoder may receive a full normal value in the bitstream rather than a difference value.

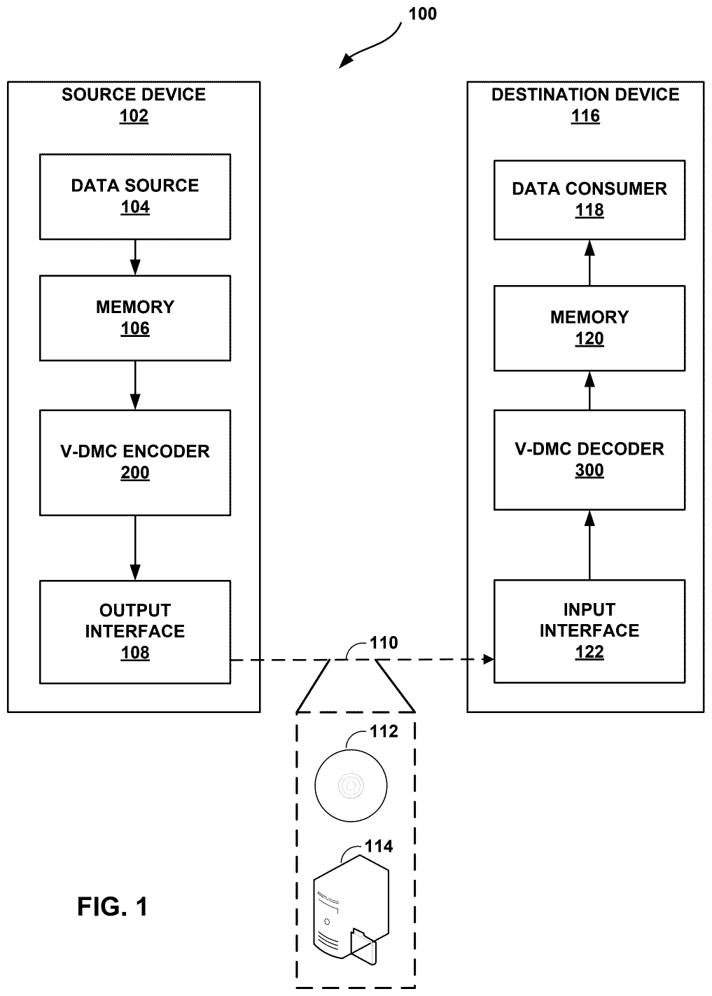

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames”) of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

Working Group 7 (WG7), often referred to as the 3D Graphics and Haptics Coding Group (3DGH), is presently engaged in standardizing the video-based dynamic mesh coding (V-DMC) for XR applications. The current testing model includes preprocessing input meshes into possibly simplified versions called “base meshes.” These base meshes may contain fewer vertices than the original mesh and may be encoded using a base mesh coder also called a static mesh coder. The preprocessing also generates displacement vectors as well as a texture attribute map that are both encoded using a video encoder. If the mesh is encoded in a lossless manner, then the base mesh is no longer a simplified version and is used to encode the original mesh. For the lossless manner, the V-DMC TMM v6.0 tool operates in intra-mode where the base mesh encoder becomes the primary encoding process.

The base mesh encoder encodes the connectivity of the mesh as well as the attributes associated with each vertex which typically involves the position and a coordinate (e.g., UV coordinates) for the texture but are not limited to these attributes. The position includes 3D coordinates (x,y,z) of the vertex while, the texture is stored as a 2D UV coordinate (x,y) that points to a texture map image pixel location. The base mesh in V-DMC is encoded using an EdgeBreaker algorithm, while the connectivity is encoded using a CLERS op code. The residual of the attribute is encoded using prediction from the previously encoded/decoded vertices.

The EdgeBreaker algorithm is described in Jean-Eudes Marvie, Olivier Mocquard, [V-DMC] [EE4.4] An efficient EdgeBreaker implementation, ISO/IEC JTC1/SC29/WG7, m63344, April 2023 (hereinafter “m63344”), which is hereby incorporated by reference. The CLERS op code is described in J. Rossignac, “3D compression made simple: EdgeBreaker with ZipandWrap on a corner-table,” in Proceedings International Conference on Shape Modeling and Applications, Genova, Italy, 2001 (hereinafter “Rossignac”) and H. Lopes, G. Tavares, J. Rossignac, A. Szymczak and A. Safonova, “EdgeBreaker: a simple compression for surfaces with handles.” in ACM Symposium on Solid Modeling and Applications, Saarbrucken, 2002 (hereinafter “Lopes”), which are both hereby incorporated by reference.

The techniques of this disclosure integrate the normal encoding in the V-DMC tool. The techniques of this disclosure integrate the per vertex normal encoding in the base mesh encoder which is also referred to as static mesh encoder as well as add support for normal maps.

A background of the V-DMC test model will now be provided. A detailed description of the proposal that was selected as the starting point for the V-DMC standardization can be found in the following documents, all of which are hereby incorporated by reference.
U.S. Provisional Patent Application 63/614,139 filed 22 Dec. 2023.
U.S. Provisional Patent Application 63/621,478 filed 16 Jan. 2024.
Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022 (hereinafter “m59281”).
V-DMC codec description, ISO/IEC JTC1/SC29/WG7, N00644, July. 2023 (hereinafter “V-DMC codec description”).
WD 4.0 of V-DMC, ISO/IEC JTC1/SC29/WG7, N00680, January 2023 (hereinafter “N00680”).

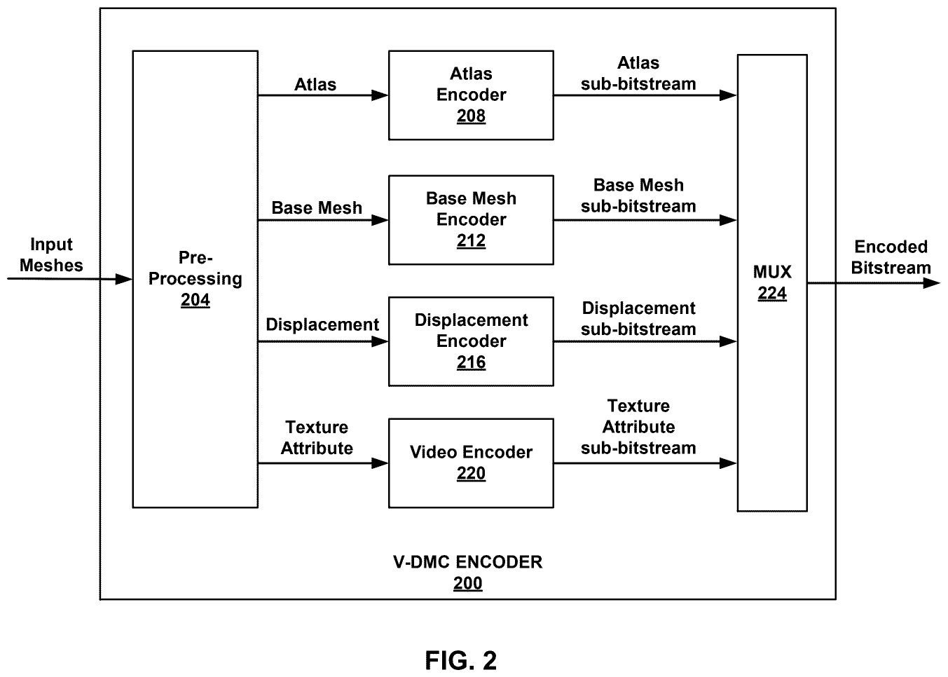

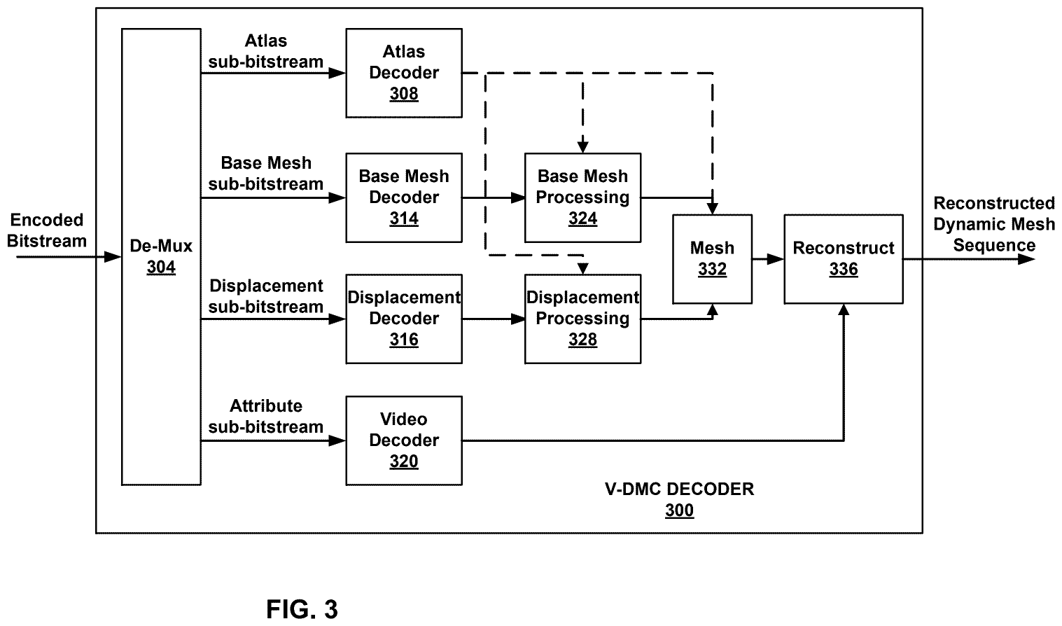

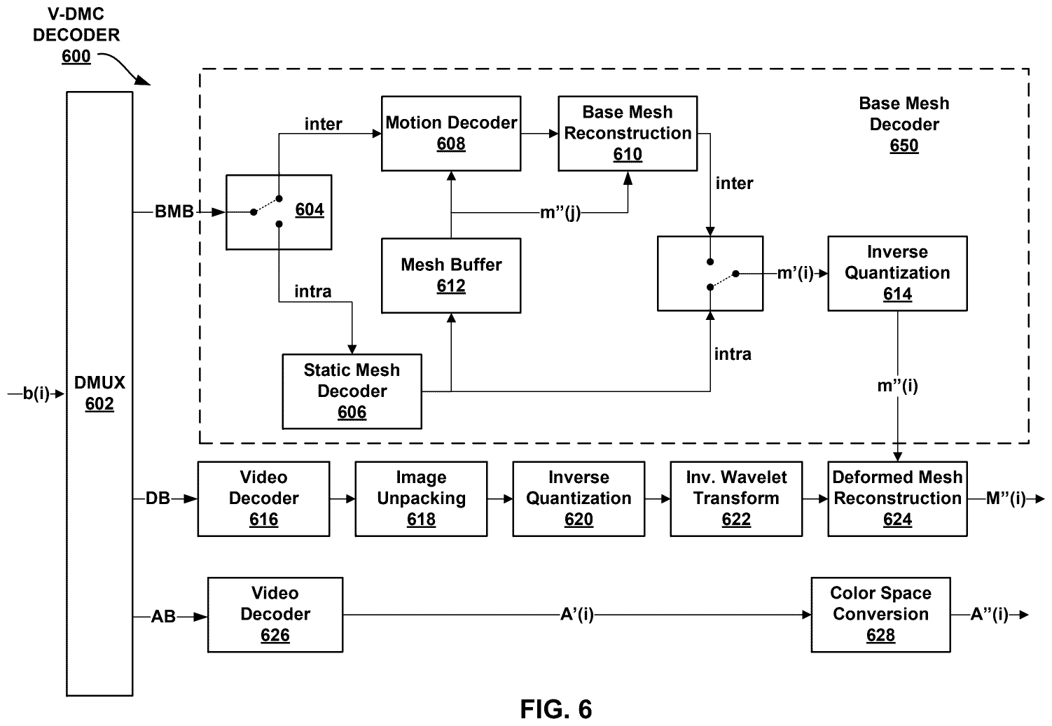

U.S. Provisional Patent Applications 63/614,139 and 63/621,478 explain the V-DMC as well as base mesh coding. FIGS. 2 and 3 show the overall system model for the current V-DMC test model (TM) including the encoder and decoder architecture. FIG. 6 shows the detailed view of the V-DMC decoder.

A mesh generally refers to a 3D data storage format where the 3D data is represented in terms of triangles. The data includes of triangle connectivity and the corresponding attributes. Mesh Attributes generally refer to attributes that can includes of a lot of things per vertex geometry (x,y,z), texture, normals, per-vertex color, etc.

Texture vs color: Texture is different from the color attribute. A color attribute includes per-vertex color whereas texture is stored as a texture map (image) and texture coordinates (UV coordinates). Each individual vertex is assigned a UV coordinates that correspond to the (x,y) location on the texture map.

Texture encoding includes encoding both the per vertex texture coordinates (UV coordinates) and the corresponding texture map. UV coordinates are encoded in the base mesh encoder while the texture map is encoded using a video encoder.

Preprocessing: The input mesh sequence first goes through the pre-processing to generate an atlas, base mesh, the displacement vectors, and the attribute maps.

Atlas Encoding: Atlas parameterization includes packing 3D mesh into a 2D atlas, i.e., texture mapping. Atlas encoder encodes the information required to parameterize the 3D mesh into a 2D texture map.

Base Mesh: For lossy encoding, the base mesh is usually a simplified mesh with possibly a smaller number of vertices. For lossless encoding, the base mesh is the original mesh with little simplification.

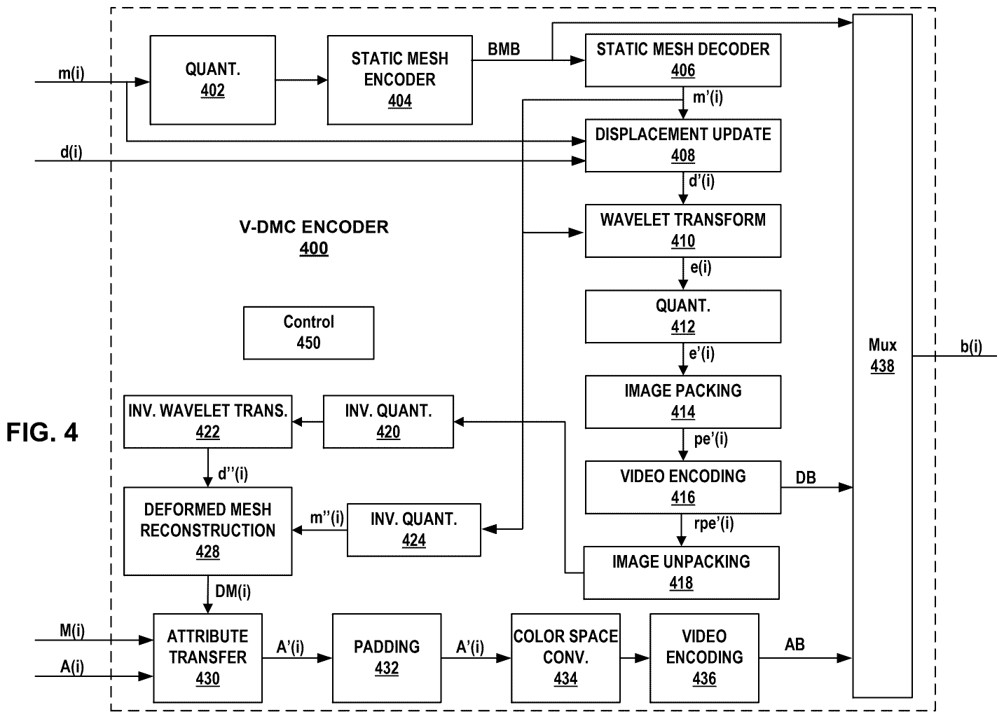

Base Mesh Encoder: The base mesh is encoded using a base mesh encoder (referred to as static mesh encoder in FIG. 4. The base mesh encoder uses EdgeBreaker to encodes the mesh connectivity and attributes (geometry, texture coordinates (UV coordinates), etc.) in a lossless manner.

Displacement Encoder: Displacements are per-vertex vectors that indicate how the base mesh is transformed/displaced to create the mesh. The displacement vectors can be encoded as V3C video component or using arithmetic displacement coding.

Texture Map Encoder: A video encoder is employed to encode the texture map.

Lossless mode: In the lossless mode there are no displacement vectors and the base mesh is not simplified. The base mesh encoder is a lossless encoder so it is sufficient for lossless mode of V-DMC. The texture map is encoded using lossless video encoder.

Lossy mode: In the lossy mode, the base mesh could be a simplified version of the original mesh. Displacement vectors are employed to subdivide and displace the base mesh to obtain reconstructed mesh. The texture map is encoded using lossy video encoder.

Normals: The normals are not currently supported in the V-DMC TMM v6.0. Like texture and color, the normals may also be per-vertex normals or may be a normal map with corresponding normal coordinates.

FIGS. 2 and 3 show the overall system model for the current V-DMC test model (TM) encoder (V-DM encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, and video encoder 220. Pre-processing unit 204 receives an input mesh sequence and generates a base mesh, the displacement vectors, and the texture attribute maps. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as the High Efficiency Video Coding (HEVC) Standard or the Versatile Video Coding (VVC) standard.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

Base mesh encoder 212 is represented as Static Mesh Encoder in FIG. 4 and employs an implementation of the EdgeBreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more sub meshes are input to base mesh encoder 212. Sub meshes are generated by pre-processing unit 204. Sub meshes are generated from original meshes by utilizing semantic segmentation. Each base mesh may include of one or more sub meshes.

Base mesh encoder 212 may process connected components. Connected components include of a cluster of triangles that are connected by their neighbors. A sub mesh can have one or more connected components. Base mesh encoder 212 may encode one “connected component” at a time for connectivity and attributes encoding and then performs entropy encoding on all “connected components”.

Base mesh encoder 212 defines and categorizes the input base mesh into the connectivity and attributes. The geometry and texture coordinates (UV coordinates) are categorized as attributes.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

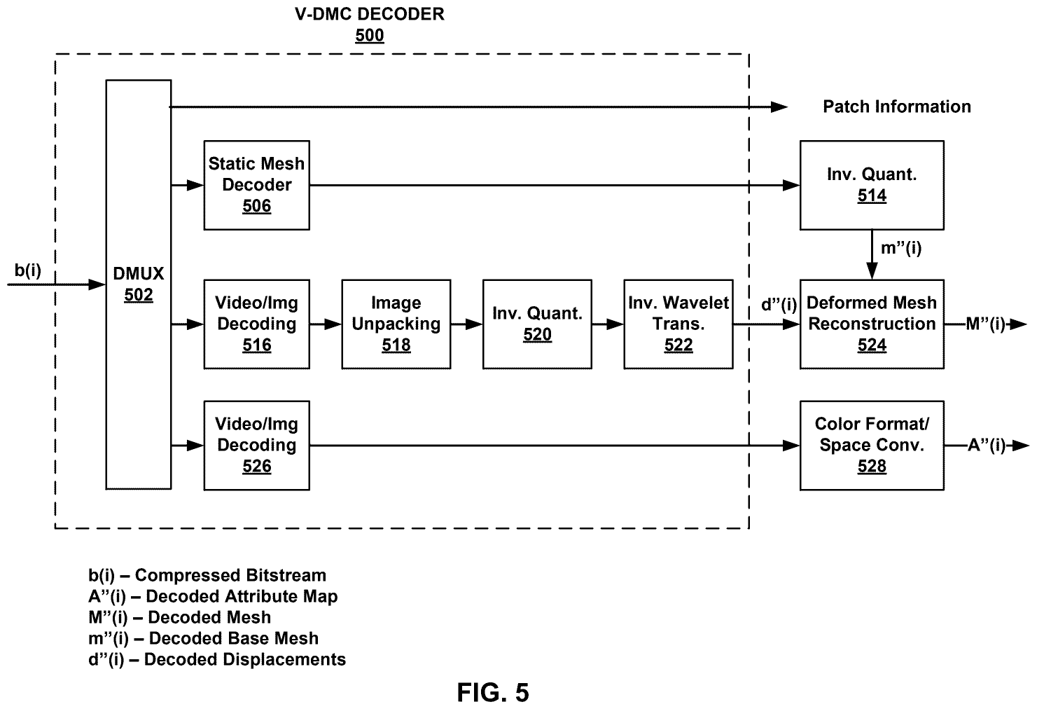

FIG. 4 shows intra-mode V-DMC encoder 400, and FIG. 5 shows an intra-mode V-DMC decoder 500. V-DMC encoder 400 generally represents a more detailed example implementation of V-DMC encoder 200, particularly with respect to intra-mode functionality, and V-DMC decoder 500 represents a more detailed example implementation of V-DMC decoder 300, particularly with respect to intra-mode functionality. FIG. 6 shows a V-DMC decoder 600, represents a more detailed example implementation of V-DMC decoder 300, particularly with respect to intra-mode and inter-mode functionality.

FIG. 4 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

V-DMC encoder 400 receives base mesh m(i) and displacements d(i), for example from a pre-processing system. V-DMC encoder 400 also retrieves mesh M (i) and attribute map A(i).

Quantization unit 402 quantizes the base mesh, and static mesh encoder 404 encodes the quantized based mesh to generate a compressed base mesh bitstream.

Displacement update unit 408 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 410 applies a wavelet transform to d′(i) to generate a set of wavelet coefficients. The scheme is agnostic of the transform applied and may leverage any other transform, including the identity transform. Quantization unit 412 quantizes wavelet coefficients, and image packing unit 414 packs the quantized wavelet coefficients into a 2D image/video that can be compressed using a traditional image/video encoder in the same spirit as V-PCC to generate a displacement bitstream.

Attribute transfer unit 430 converts the original attribute map A(i) to an updated attribute map that corresponds to the reconstructed deformed mesh DM(i). Padding unit 432 pads the updated attributed map by, for example, filling patches of the frame that have empty samples with interpolated samples that may improve coding efficiency and reduce artifacts. Color space conversion unit 434 converts the attribute map into a different color space, and video encoding unit 436 encodes the updated attribute map in the new color space, using for example a video codec, to generate an attribute bitstream.

Multiplexer 438 combines the compressed attribute bitstream, compressed displacement bitstream, and compressed base mesh bitstream into a single compressed bitstream.

Image unpacking unit 418 and inverse quantization unit 420 apply image unpacking and inverse quantization to the reconstructed packed quantized wavelet coefficients generated by video encoding unit 416 to obtain the reconstructed version of the wavelet coefficients. Inverse wavelet transform unit 422 applies and inverse wavelet transform to the reconstructed wavelet coefficient to determine reconstructed displacements d″(i).

Inverse quantization unit 424 applies an inverse quantization to the reconstructed quantized base mesh m′(i) to obtain a reconstructed base mesh m″(i). Deformed mesh reconstruction unit 428 subdivides m″(i) and applies the reconstructed displacements d″(i) to its vertices to obtain the reconstructed deformed mesh DM(i).

Image unpacking unit 418, inverse quantization unit 420, inverse wavelet transform unit 422, and deformed mesh reconstruction unit 428 represent a displacement decoding loop. Inverse quantization unit 424 and deformed mesh reconstruction unit 428 represent a base mesh decoding loop. V-DMC encoder 400 includes the displacement decoding loop and the base mesh decoding loop so that V-DMC encoder 400 can make encoding decisions, such as determining an acceptable rate-distortion tradeoff, based on the same decoded mesh that a mesh decoder will generate, which may include distortion due to the quantization and transforms. V-DMC encoder 400 may also use decoded versions of the base mesh, reconstructed mesh, and displacements for encoding subsequent base meshes and displacements.

Control unit 450 generally represents the decision making functionality of V-DMC encoder 400. During an encoding process, control unit 450 may, for example, make determinations with respect to mode selection, rate allocation, quality control, and other such decisions.

FIG. 5 shows a block diagram of an intra decoder which may, for example, be part of V-DMC decoder 300. De-multiplexer (DMUX) 502 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 502 feeds the mesh sub-stream to static mesh decoder 506 to generate the reconstructed quantized base mesh m′(i). Inverse quantization unit 514 inverse quantizes the base mesh to determine the decoded base mesh m″(i). Video/image decoding unit 516 decodes the displacement sub-stream, and image unpacking unit 518 unpacks the image/video to determine quantized transform coefficients, e.g., wavelet coefficients. Inverse quantization unit 520 inverse quantizes the quantized transform coefficients to determine dequantized transform coefficients. Inverse transform unit 522 generates the decoded displacement field d″(i) by applying the inverse transform to the unquantized coefficients. Deformed mesh reconstruction unit 524 generates the final decoded mesh (M″(i)) by applying the reconstruction process to the decoded base mesh m″(i) and by adding the decoded displacement field d″(i). The attribute sub-stream is directly decoded by video/image decoding unit 526 to generate an attribute map A″(i). Color format/space conversion unit 528 may convert the attribute map into a different format or color space.

FIG. 6 shows V-DMC decoder 600, which is an example implementation V-DMC decoder 300. V-DMC decoder 600 includes demultiplexer (DMUX) 602, which receives compressed bitstream b (i) and separates the compressed bitstream into a base mesh bitstream (BMB), a displacement bitstream (DB), and an attribute bitstream (AB). Mode select unit 604 determines if the base mesh data is encoded in an intra mode or an inter mode. If the base mesh is encoded in an intra mode, then static mesh decoder 606 decodes the mesh data without reliance on any previously decoded meshes. If the base mesh is encoded in an inter mode, then motion decoder 608 decodes motion, and base mesh reconstruction unit 610 applies the motion to an already decoded mesh (m″(j)) stored in mesh buffer 612 to determine a reconstructed quantized base mesh (m′(i))). Inverse quantization unit 614 applies an inverse quantization to the reconstructed quantized base mesh to determine a reconstructed base mesh (m″(i)).

Video decoder 616 decodes the displacement bitstream to determine a set or frame of quantized transform coefficients. Image unpacking unit 618 unpacks the quantized transform coefficients. For example, video decoder 616 may decode the quantized transform coefficients into a frame, where the quantized transform coefficients are organized into blocks with particular scanning orders. Image unpacking unit 618 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 620 inverse quantizes, e.g., inverse scales, quantized transform coefficients to determine de-quantized transform coefficients. Inverse wavelet transform unit 622 applies an inverse transform to the de-quantized transform coefficients to determine a set of displacement vectors. Deformed mesh reconstruction unit 624 deforms the reconstructed base mesh using the decoded displacement vectors to determine a decoded mesh (M″(i)).

Video decoder 626 decodes the attribute bitstream to determine decoded attribute values (A′(i)), and color space conversion unit 628 converts the decoded attribute values into a desired color space to determine final attribute values (A″(i)). The final attribute values correspond to attributes, such as color or texture, for the vertices of the decoded mesh.

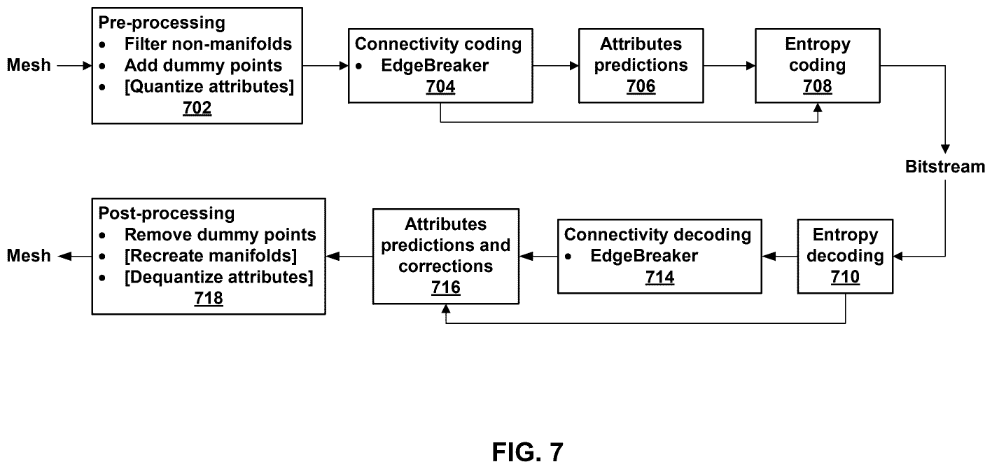

FIG. 7: Overview of the complete EdgeBreaker mesh codec, top row is the encoding line, bottom row is the decoding line, as described in m63344. FIG. 7 illustrates the end-to-end mesh codec based on EdgeBreaker, which includes the following primary steps:

### Encoding:

Pre-processing (702): Initially, a pre-processing is performed to rectify potential connectivity issues in the input mesh, such as non-manifold edges and vertices. This step is crucial because the EdgeBreaker algorithm employed cannot operate with such connectivity problems. Addressing non-manifold issues may involve duplicating some vertices, which are tracked for later merging during decoding. This optimization reduces the number of points in the decoded mesh but necessitates additional information in the bitstream. Dummy points are also added in this pre-processing phase to fill potential surface holes, which EdgeBreaker does not handle. The holes are subsequently encoded by generating “virtual” dummy points by encoding dummy triangles attached to them, without requiring 3D position encoding. If needed, the vertex attributes are quantized in the pre-processing.
Connectivity Encoding (704): Next, the mesh's connectivity is encoded using a modified EdgeBreaker algorithm, generating a CLERS table along with other memory tables used for attribute prediction.
Attribute Prediction (706): Vertex attributes are predicted, starting with geometry position attributes, and extending to other attributes, some of which may rely on position predictions, such as for texture UV coordinates.
Bitstream Configuration (708): Finally, configuration and metadata are included in the bitstream. This includes the entropy coding of CLERS tables and attribute residuals.

### Decoding:

Entropy Decoding (710): The decoding process commences with the decoding of all entropy-coded sub-bitstreams.
Connectivity Decoding (714): Mesh connectivity is reconstructed using the CLERS table and the EdgeBreaker algorithm, with additional information to manage handles that describe topology.
Attributes Predictions and Corrections (716): Vertex positions are predicted using the mesh connectivity and a minimal set of 3D coordinates. Subsequently, attribute residuals are applied to correct the predictions and obtain the final vertex positions. Other attributes are then decoded, potentially relying on the previously decoded positions, as is the case with UV coordinates. The connectivity of attributes using separate index tables is reconstructed using binary seam information that is entropy coded on a per-edge basis.
Post-processing (718): In a post-processing stage, dummy triangles are removed. Optionally, non-manifold issues are recreated if the codec is configured for lossless coding. Vertex attributes are also optionally dequantized if quantized during encoding.

The data representation for base mesh coding will now be described. The EdgeBreaker algorithm utilizes the corner table data representation, a concept initially introduced by Rossignac to enhance the efficiency of the EdgeBreaker algorithm. A comprehensive overview of the properties of the corner table (CT) can be found in Rossigniac.

Aspects of attribute coding in base mesh coding will now be described. The base mesh encoder encodes both the attributes and the connectivity of the triangles and vertices. The attributes are typically encoded using a prediction scheme to predict the vertex attribute using previously visited/encoded/decoded vertices. Then the prediction is subtracted from the actual attribute value to obtain the residual. Finally, the residual attribute value is encoded using an entropy encoder to obtain the encoded base mesh attribute bitstream. The attribute bitstream which contains vertex attribute usually has the geometry/position attribute and the UV coordinates (texture attribute) but can contain any number of attributes like per vertex RGB values, etc.

Attribute coding uses a prediction scheme to find the residuals between the predicted and actual attributes. Finally, the residuals are entropy encoded into a base mesh attribute bitstream. Each vertex attribute is encoded differently. The geometry for 3D position and the UV coordinates for the texture are both encoded using prediction processes. To compute these predictions, the multi-parallelogram technique is utilized for geometry encoding, as described in Cohen and Isenburg, while the min stretch process is employed for UV coordinates encoding, as described in I. M. and S. J., “Compressing Texture Coordinates with Selective Linear Predictions,” in Computer Graphics International, Tokyo, Japan, 2003, which is hereby incorporated by reference.

It is worth noting that during the prediction of a corner, it can be ensured that its associated triangle fan is always complete, and each of its corners has a valid opposite. This is achieved by employing dummy points to fill any holes. In fact, even a single triangle would be transformed into a pyramid composed of four triangles in terms of connectivity.

The code for attribute compression is shown in Table 1. The geometry prediction uses multi-parallelogram scheme shown in Table 2. The Min stretch prediction scheme for UV coordinates is described in Table 3 and Table 4.

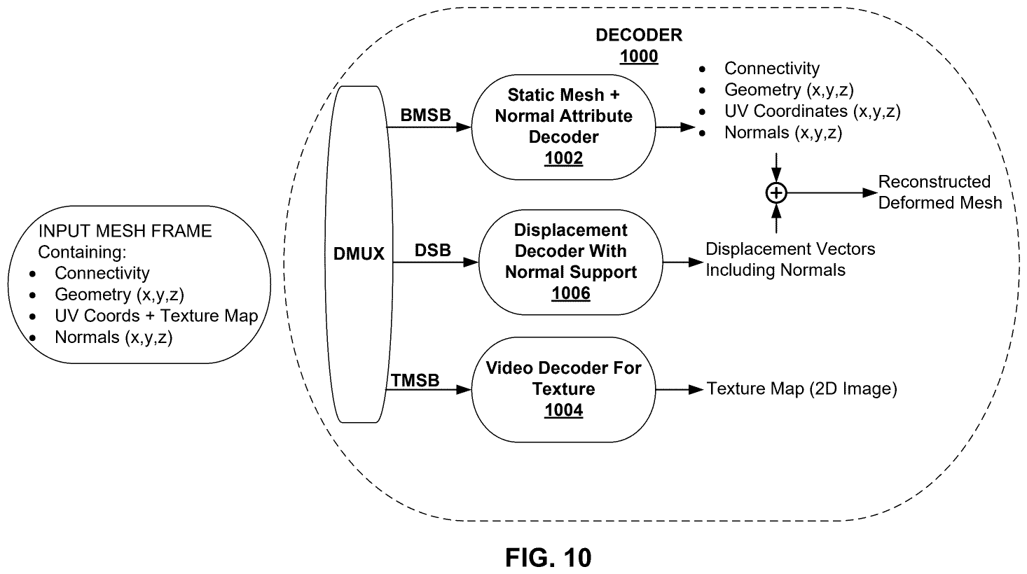

The processing of the multi-parallelogram for a given corner involves performing a lookup all around its vertex to calculate and aggregate each parallelogram prediction, utilizing opposite corners, as shown in FIGS. 10A and 10B. A parallelogram used to predict a corner from a sibling corner is considered valid for prediction only if the vertices of the corner itself, the sibling corner, and their shared vertex have been previously processed by the connectivity recursion, which triggers the prediction. To verify this condition, the vertex marking table (designated as M) is employed. This table contains elements set to true for vertices that have already been visited by the connectivity encoding loop. In the parallelogram prediction, the parallelogram moves in an anti-clockwise direction by swinging around the “triangle fan”. If in a parallelogram, the next, previous, and opposite vertices are available, then that parallelogram (and the three other vertices) is used to predict the current vertices' position.

At the end of the loop, the sum of predictions is divided by the number of valid parallelograms that have been identified. The result is rounded and subsequently used to compute the residual (position-predicted), which is appended to the end of the output vertices table. In cases where no valid parallelogram is found, a fallback to delta coding is employed.

For encoding predictions of UV coordinates using primary index tables, the procedure follows a similar extension to that used for positions. The key distinction lies in the utilization of the min stretch approach rather than multi-parallelogram for prediction. Additionally, predictions are not summed up; instead, the process halts at the first valid (in terms of prediction) neighbor within the triangle fan, and the min stretch is computed, as depicted in FIGS. 10A and 10B. Further details of the uvEncodeWithPrediction procedure can be found in Table 3, while the actual prediction statement is illustrated in Table 4.

The V-DMC tool has also added support for multiple attributes where a mesh can have more than one texture map. Similarly, base mesh encoder also has support added for separate index for UV coordinates. In this case the UV Coordinates do not have to be in the same order as the position (primary attribute).

The code shown in Tables 1-4 is only for the encoding side (encoder). The decoder follows similar steps but in reverse.

TABLE 1
Encoder Attributes

```
  void EBBasicEncoder::encodeMainIndexAttributes(const int c, const int v)
  {
    const auto& V = _ovTable.V;
    const auto& G = _ovTable.positions;
    const auto& UV = _ovTable.uvcoords;
    const auto& OTC = _ovTable.OTC;
    const bool predictUVs = (UV.size( ) && !OTC.size( )); // predict UVs in first
pass if no separate index
    bool bypasspos = false;
    if (cfg.deduplicate)
    {
      // check for duplicated positions
      const auto dupIt = _ovTable.duplicatesMap.find(_ovTable.V[c]);
      if (dupIt != _ovTable.duplicatesMap.end( ))
      {
        isVertexDup.push_back(true);
        oDuplicateSplitVertexIdx.push_back(dupIt−>second);
      }
      else
        isVertexDup.push_back(false);
      Vcur++;
      // early return if duplicate already coded
      if (dupIt != _ovTable.duplicatesMap.end( ))
      {
        if (processedDupIdx.find(dupIt−>second) != processedDupIdx.end( ))
        {
          bypasspos = true; // no need to encode as already processed
          posSkipDup++;
        }
        else
          processedDupIdx.insert(dupIt−>second);
      }
      // then use duplicate pos info to replicate the value when decoding
    }
    // reindex the dummy vertices
    if (isCornerVertexDummy(c))
    {
      // reindexation is dependent on how some values are separately encoded
      if (cfg.posPred != EBConfig::PosPred::MPARA)
        oDummies.push_back(oVertices.size( ));
      else
        oDummies.push_back(oVertices.size( ) + sVertices.size( ) +
oDummies.size( ) + posSkipDup);
    }
    if (!bypasspos)
    {
      // positions
      switch (cfg.posPred) {
      case EBConfig::PosPred::NONE:
        oVertices.push_back(G[V[c]]);
        break;
      case EBConfig::PosPred::MPARA:
        posEncodeWithPrediction(c, v);
        break;
      }
      // UVCoords
      if (predictUVs) {
        switch (cfg.uvPred) {
        case EBConfig::UvPred::NONE:
          oUVCoords.push_back(UV[V[c]]);
          break;
        case EBConfig::UvPred::STRETCH:
          uvEncodeWithPrediction(c, v);
          break;
        }
      }
    }
  }
```

TABLE 2
posEncodeWithPrediction using multi-parallelogram

```
  void EBBasicEncoder::posEncodeWithPrediction(const int c, const int v)
  {
    const auto MAX_PARALLELOGRAMS = 4;
    const auto& OV = _ovTable;
```

| | |
|---|---|
| const auto& V = _ovTable.V; | // NO CC SHIFTING |
| const auto& O = _ovTable.O; | // NO CC SHIFTING |
| const auto& G = _ovTable.positions; | // NO CC SHIFTING |

```
    // use a separate table for start and dummy vertices => less unique symbols for
entropy coding
    if ((v == 0) || isCornerVertexDummy(c))
    {
      if (v == 0)
```

| | |
|---|---|
| sVertices.push_back(G[V[c]]); | // start point, store as global |

```
coordinate
      return;
    }
```

| | |
|---|---|
| switch (v) { | // case 0 already handled along with |

dummies

| | |
|---|---|
| case 1: | // store delta, |
| case 2: | // store delta, |

oVertices.push_back(G[V[c] − G[V[OV.p(c)]]); break;

| | |
|---|---|
| default: | // store parallelogram estimation |

```
      bool prevIsDummy = isCornerVertexDummy(OV.p(c));
      // search for some parallelogram estimations around the vertex of the corner
      int count = 0;
      int altC = c;
```

| | |
|---|---|
| glm::vec3 predPos(0, 0, 0); | // the predicted position |
| do | // loop through corners attached to the |

```
current vertex
      {
        if (count >= MAX_PARALLELOGRAMS) break;
        if (((!isCornerVertexDummy(O[altC])) &&
          (!isCornerVertexDummy(OV.p(altC))) &&
          (!isCornerVertexDummy(OV.n(altC)))) &&
          ((M[V[O[altC]]] > 0) && (M[V[OV.p(altC)]] > 0) &&
(M[V[OV.n(altC)]] > 0)))
        {
          // parallelogram prediction estG = prevG + nextG − oppoGd
          glm::vec3 estG = G[V[OV.p(altC)]] + G[V[OV.n(altC)]] −
```

| | |
|---|---|
| G[V[O[altC]]; | |
| predPos += estG; | // accumulate parallelogram predictions |

```
          ++count;
        }
```

| | |
|---|---|
| altC = OV.p(O[OV.p(altC)]); | // swing around the triangle fan |

} while (altC != c);

| | |
|---|---|
| if (count > 0) | // use parallelogram prediction |

when possible

| | |
|---|---|
| predPos = glm::round(predPos / glm::vec3(count)); | // divide and |

round each component of vector predPos

| | |
|---|---|
| else | // or fallback to delta with available |

```
values
        // G[V[OV.n(c)]] cannot be dummy if prevIsDummy and is necessarily
marked
        predPos = prevIsDummy ? G[V[OV.n(c)]] : G[V[OV.p(c)]];
```

| | |
|---|---|
| oVertices.push_back(G[V[c]] − predPos); | // store the residual = position − |

predicted

| | |
|---|---|
| } | // end of switch |

}

TABLE 3
uvEncodeWithPrediction

```
  void EBBasicEncoder::uvEncodeWithPrediction(const int c, const int v) {
    auto& OV = _ovTable;
    auto& V = _ovTable.V;
    auto& O = _ovTable.O;
    auto& G = _ovTable.positions;
    auto& UV = _ovTable.uvcoords;
    // use a separate table for start and dummy uv coords => less unique symbols
for entropy coding
    if ((v == 0) || isCornerVertexDummy(c))
    {
      if (v == 0)
```

| | |
|---|---|
| sUVCoords.push_back(UV[V[c]]); | // start point, store as global |

```
coordinate
      // this introduces a shift to be handled when decoding as no related
oUVCoords.push_back exist
      return;
    }
    // switch on vertex index. case 0 already handled with dummies
    switch (v) {
```

| | |
|---|---|
| case 1: | // delta, |
| case 2: | // delta, |

oUVCoords.push_back(UV[V[c]] − UV[V[OV.p(c)]]); break;

| | |
|---|---|
| default: | // parallelogram |

```
      bool prevIsDummy = isCornerVertexDummy(OV.p(c));
      bool nextIsDummy = isCornerVertexDummy(OV.n(c));
      bool predWithDummies = nextIsDummy || prevIsDummy;
      if (predWithDummies)
      {
        int count = 0;
        bool last = false;
        int altC = c;
        glm::vec3 predPos(0.0, 0.0, 0.0);
```

| | |
|---|---|
| do | // loop through corners attached to the current |

vertex
{

| | |
|---|---|
| if (count >= 1) break; | // no multiple predictions, stop on first |

```
corner found
          if ((c != altC) && isCornerVertexDummy(altC))
          { // stop after looping in both directions or if a complete turn
achieved
            if (last) break;
            altC = c;
            last = true;
          }
          // ensure that p.n from altC with same V[altC] are already decoded and
are not dummies
          else if (((!isCornerVertexDummy(OV.p(altC))) &&
(!isCornerVertexDummy(OV.n(altC))))
            && ((M[V[OV.p(altC)]] > 0) && (M[V[OV.n(altC)]] > 0)))
          {
            glm::vec2 estUV(0, 0);
            glm::dvec2 firstestUV(0, 0);
            predictUV(altC, estUV, firstestUV, V, true, true, prevIsDummy);
            oUVCoords.push_back(UV[V[c] − glm::round(estUV));
            ++count;
          }
          altC = (!last) ? OV.p(O[OV.p(altC)]) : OV.n(O[OV.n(altC)]); // swing
right or left
        } while (altC != c);
        if (count == 0) // no corner found
        {
          glm::vec2 predUV = prevIsDummy ? UV[V[OV.n(c)]] :
UV[V[OV.p(c)]];
          const auto resUV = UV[V[c]] − predUV;
          oUVCoords.push_back(resUV);
        }
      }
      else
      {//without dummy vertex
        int count = 0;
        int altC = c;
        glm::vec2 predUV(0, 0);
        bool first = true;
        glm::dvec2 firstestUV(0, 0);
        do {
          glm::vec2 estUV(0, 0);
          if (((!isCornerVertexDummy(OV.p(altC))) &&
            (!isCornerVertexDummy(OV.n(altC)))) &&
            ((M[V[OV.p(altC)]] > 0) && (M[V[OV.n(altC)]] > 0)))
          {
            predictUV(altC, estUV, firstestUV, V, false, first);
            predUV += estUV;
            ++count;
          }
          altC = OV.p(O[OV.p(altC)]);
          first = false;
        } while (altC != c);
        if (count > 0) {
          predUV = glm::round(predUV / glm::vec2(count));
          oUVCoords.push_back(UV[V[c]] − predUV);
        }
      }
      break;
    } // end of switch
  }
```

TABLE 4
PredictUV

```
  // c corner to use for the prediction,
  // predWithDummies boolean to predict using the dummy branch
  // prevIsDummy set to true if previous corner is a dummy point (default to false)
  void EBBasicEncoder::predictUV(const int c, glm::vec2& predUV,
glm::dvec2& firstpredUV, const std::vector<int> & indices, bool predWithDummies,
bool first, bool prevIsDummy)
  {
    const auto& OV = _ovTable;
    const auto& V = _ovTable.V;
    const auto& G = _ovTable.positions;
    const auto& UV = _ovTable.uvcoords;
    const auto& IDX = indices;
    const auto& O = _ovTable.O;
    const auto& ov = _ovTable;
    // do not accumulate uv predictions, stop on first
    glm::dvec2 uvPrev = UV[IDX[OV.p(c)]];
    glm::dvec2 uvNext = UV[IDX[OV.n(c)]];
    glm::dvec2 uvCurr = UV[IDX[c]];
    glm::dvec3 gPrev = G[V[OV.p(c)]];
    glm::dvec3 gNext = G[V[OV.n(c)]];
    glm::dvec3 gCurr = G[V[c]];
    glm::dvec3 gNgP = gPrev − gNext;
    glm::dvec3 gNgC = gCurr − gNext;
    glm::dvec2 uvNuvP = uvPrev − uvNext;
    double gNgP_dot_gNgC = glm::dot(gNgP, gNgC);
    double d2_gNgP = glm::dot(gNgP, gNgP);
    if (d2_gNgP > 0)
    {
      glm::dvec2 uvProj = uvNext + uvNuvP * (gNgP_dot_gNgC / d2_gNgP);
      glm::dvec3 gProj = gNext + gNgP * (gNgP_dot_gNgC / d2_gNgP);
      double d2_gProj_gCurr = glm::dot(gCurr − gProj, gCurr − gProj);
      const glm::dvec2 uvProjuvCurr = glm::dvec2(uvNuvP.y, −uvNuvP.x) *
std::sqrt(d2_gProj_gCurr / d2_gNgP);
      glm::dvec2 predUV0(uvProj + uvProjuvCurr);
      glm::dvec2 predUV1(uvProj − uvProjuvCurr);
      if (first) {
        //the first triangle
        bool useOpp = false;
        bool flag = false;
        if (ov.OTC.size( )) {
          // if hasUV and separate table
          if (IDX[O[c]] >= 0) {
            if (MC[IDX[O[c]]] > 0) {
              flag = true;
            }
          }
        }
        else {
          if (IDX[O[c]] >= 0) {
            if ((M[IDX[O[c]]] > 0)&&(!isCornerVertexDummy(O[c]))) {
              flag = true;
            }
          }
        }
        if (flag) {
          glm::dvec2 uvOpp = UV[IDX[O[c]]];
          float triangleArea_o = abs(0.5 * (uvNext[0] * uvPrev[1] + uvPrev[0] *
uvOpp[1] + uvOpp[0] *
        uvNext[1] − uvNext[0] * uvOpp[1] − uvPrev[0] * uvNext[1] − uvOpp[0] *
  uvPrev[1]));
          if (triangleArea_o < DBL_EPSILON) {
            //If the texture triangle is a degenerate triangle, do not use opposite
corner
            useOpp = false;
          }
          else {
            useOpp = true;
          }
        }
        if (useOpp) {
          glm::dvec2 uvOpp = UV[IDX[O[c]]];
          if (length(uvOpp − predUV0) < length(uvOpp − predUV1)) {
            predUV = predUV1;
          }
          else {
            predUV = predUV0;
            }
        }
        else {
          bool orientation = length(uvCurr − predUV0) < length(uvCurr −
predUV1);
          predUV = round(orientation ? predUV0 : predUV1);
          glm::vec2 resUV = UV[IDX[c]] − predUV;
          orientations.push_back(orientation);
        }
        firstpredUV = predUV;
      }
      else {
        if (length(firstpredUV − predUV0) < length(firstpredUV − predUV1)) {
          predUV = predUV0;
        }
        else {
          predUV = predUV1;
        }
      }
    }
    else
    {
      if (predWithDummies) // if next or prev corner is a
dummy point
      {
        predUV = prevIsDummy ? UV[IDX[OV.n(c)]] : UV[IDX[OV.p(c)]];
      }
      else // else average the two predictions
      {
        predUV = round((UV[IDX[OV.n(c)]] + UV[IDX[OV.p(c)]]) / 2.0f);
      }
      glm::vec2 resUV = UV[IDX[c] − predUV;
    }
  }
```

Currently, the V-DMC software involves a base mesh encoder. The base mesh encoder encodes both the attributes and the connectivity of the triangles and vertices. The attributes are typically encoded using a prediction scheme to predict the vertex attribute using previously visited/encoded/decoded vertices. Then the prediction is subtracted from the actual attribute value to obtain the residual. Finally, the residual attribute value is encoded using an entropy encoder to obtain the encoded base mesh attribute bitstream. The attribute bitstream which contains vertex attribute usually has the geometry/position attribute and the UV coordinates (texture attribute) but can contain any number of attributes like normals, per vertex RGB values, etc.

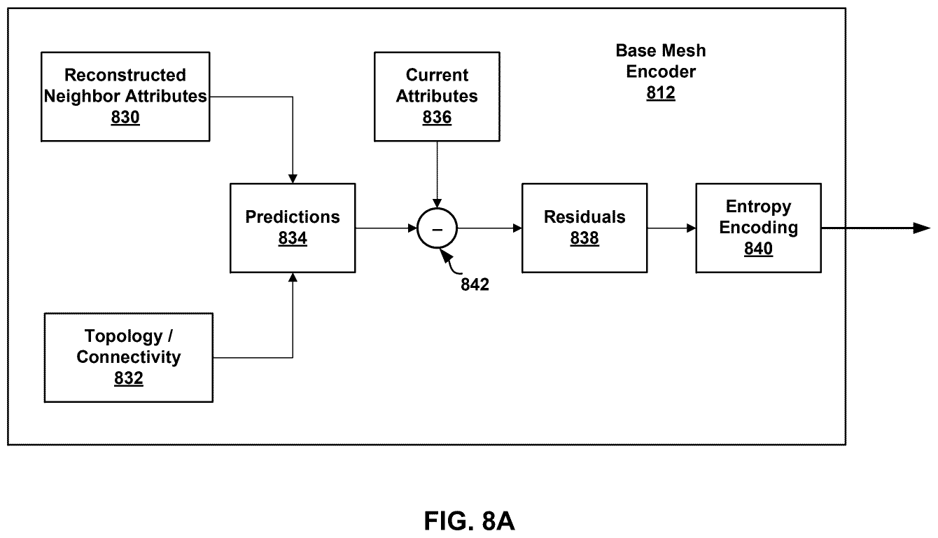

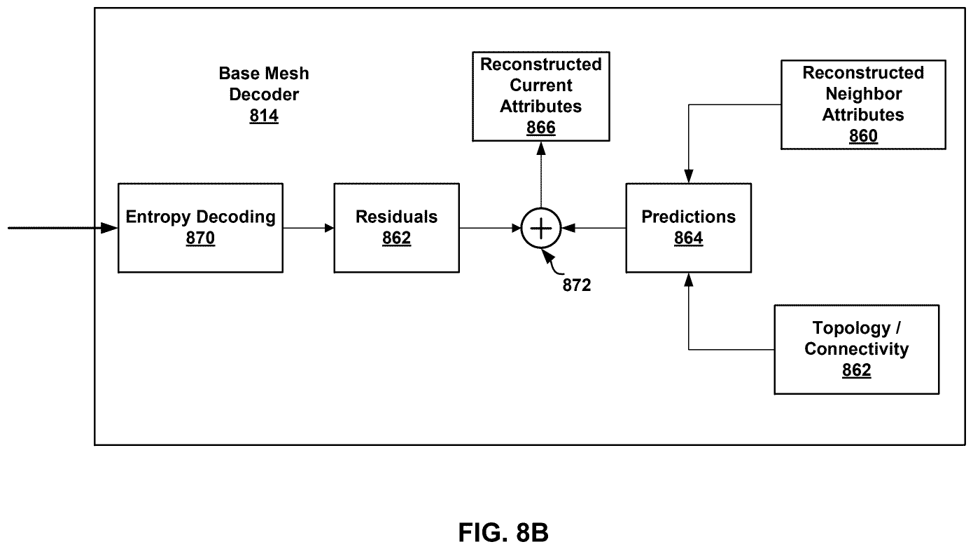

The attribute encoding procedure in the base mesh encoder is shown in FIG. 8A and includes:
Topology/Connectivity: The topology in the base mesh is encoded through the EdgeBreaker using the CLERS op code. This contains not just the connectivity information but also the data structure for the mesh (current implementation employs corner table). The topology/connectivity information is employed to find the neighboring vertices.
Attributes: These include Geometry (3D coordinates), UV Coordinates (Texture), Normals, RGB values, etc.
Neighboring attributes: These are the attributes of the neighboring vertices that are employed to predict the current vertex's attribute.
Current Attributes: This is the attribute of the current vertex. The predicted attribute is subtracted from the current vertex attribute to obtain the residuals.
Predictions. These predictions may be obtained from the connectivity and/or from the previously visited/encoded/decoded vertices. E.g., multi-parallelogram process for geometry, min stretch scheme for UV coordinates, etc.
Residuals. These are obtained by subtracting the predictions from original attributes. (e.g., residuals=current_vertex_attribute−predicted_attribute).
Entropy Encoding. Finally, the Residuals are entropy encoded to obtain the bitstream.

FIGS. 8A and 8B show an encoder and decoder architecture for base mesh encoding/decoding (also referred to as static mesh encoding/decoding). FIG. 8A shows base mesh encoder 812, which represents an example implementation of base mesh encoder 212 in FIG. 2, and FIG. 8B shows base mesh decoder 814, which represents an example implementation of base mesh decoder 314 in FIG. 3.

In the example of FIG. 8A, base mesh encoder 812 determines reconstructed neighbor attributes 830 and topology/connectivity information 832 to determine predictions 834. Base mesh encoder 812 subtracts (842) predictions 834 from current attributes 836 to determine residuals 838. Reconstructed neighbor attributes 830 represent the decoded values of already encoded vertex attributes, and current attributes 836 represent the actual values of unencoded vertex attributes. Thus, residuals 838 represent the differences between actual values of unencoded vertex attributes and predicted values for those vertex attributes. Base mesh encoder 812 may entropy encode (840) residuals 838.

In the example of FIG. 8B, base mesh decoder 814 determines reconstructed neighbor attributes 860 and topology/connectivity information 862 to determine predictions 864 in the same manner that base mesh encoder 812 determines predictions 834. Base mesh decoder 814 entropy decodes (870) the entropy encoded residual values to determine residuals 868. Base mesh decoder 814 adds (1172) predictions 864 to residuals 868 to determine reconstructed current attributes 866. Reconstructed current attributes 866 represent the decoded versions of current attributes 836.

The base mesh encoder is an integral part of the V-DMC structure. Lossless encoding in V-DMC relies heavily on the base mesh encoder while in the lossless encoder the quality of the base mesh encoding greatly effects the final reconstructed mesh. Base mesh encoder also forms a significant portion of the V-DMC's overall bitstream. Therefore, there may be a need to further decrease the bitstream size of the base mesh encoder. The attribute bitstream envelops large amount of the base mesh encoded bitstream. The attribute bitstream contains the residual attribute values. It can be observed that the entropy of these residuals is still large and there is still correlation between neighboring vertices' residuals. A goal may be to decrease the size of the attribute bitstream and further decrease the entropy of the attributes and/or the residuals that are to be encoded for the base mesh.

Normals are vectors that are perpendicular to the surface of a mesh. Normals may be used to determine the orientation of the surface and to apply shading. In 3D modeling, normals play a crucial role in creating realistic-looking objects. Normals help to define the shape of the object and how it interacts with light. Normals are also used in computer graphics to create smooth surfaces and to calculate the reflection of light. In addition, normals are used in video games to create realistic-looking environments and to improve the performance of the game. In summary, normals are an essential component of 3D modeling and computer graphics and are used in a wide range of applications, from video games to scientific simulations.

The current version of the V-DMC Test Model v6.0 (TMM v6.0) supports encoding of position and texture data for a mesh but lacks the integration of normal encoding. The V-DMC's base mesh coding in m63344 encodes the mesh's connectivity, while the position and texture are encoded as attributes of the vertices. There is a need in dynamic mesh coding to incorporate and support for normal encoding as an attribute of the mesh. This disclosure describes techniques to introduce the implementation of normal encoding into the V-DMC TMM v6.0 including the base mesh EdgeBreaker implementation in m63344. This disclosure describes techniques for the encoding of normals as well as normal maps in the V-DMC TMM.

This disclosure describes techniques for the following:
Integrate Normals encoding in V-DMC.
Propose normal maps encoding in V-DMC.
Propose per-vertex normal encoding in V-DMC.
Integrate Normal encoding in base mesh encoder within V-DMC.
Propose prediction schemes for normal encoding in base mesh encoder.

The Base mesh decoder in the current version of V-DMC is shown as base mesh decoder 650 in FIG. 6. Aspects of system architecture will now be described. This disclosure categorizes normals encoding into two types/categories. Normal encoding generally refers to the per-vertex normal values, meaning each vertex may have a corresponding normal vector (x,y,z). Normal Map Encoding generally refers to using normal maps that include 2D normal images containing the normal values and the corresponding per-vertex normal coordinates (u,v). The normal coordinates give the location of the normal value on the normal map.

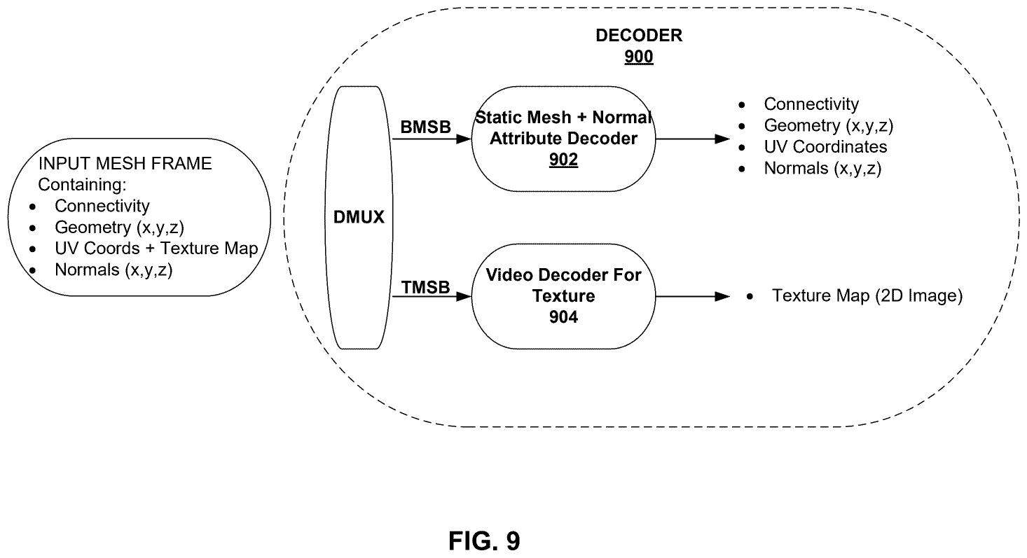

The V-DMC coding conditions can be categorized as (1) Lossless mode: Intra compression, (2) Lossy mode: Intra compression, (3) Lossy mode: Inter compression. FIGS. 9-14 show the updates to the V-DMC architecture with for all three conditions for both the normal encoding as well as normal map encoding. The architecture of these figures is generally the same as FIGS. 5, 6, and 7 with just the per-vertex normal encoding added to the architecture.

### Video Decoder for Normal Map.

The techniques of this disclosure may employ the same video decoder as employed in texture map encoding to encode the Normal Maps.

Displacement Decoder with Normal Support.

The displacement vector for normals may be employed like how the displacement vector for positional encoding is employed in the V-DMC.

Displacement vectors for normals change the direction of the normals and can be one dimensional or three dimensional. The displacement vectors for normals may be encoded in the same manner as displacement vectors for position shown in FIGS. 4-6.

Motion Decoder with Normal Support.

The motion encoding/decoding for normals may be implemented in the same manner as the motion encoding/decoding for position. The motion vector changes the normals from one frame to the next and is only employed in inter-prediction coding mode.

Static Mesh Decoder with Normal Support.

This Static Mesh encoder works for Normal Map Encoding. With Normal Maps, there is a need to encode the 2D normal map coordinates (u,v). It may be implemented in two ways. The Normal Maps can either employ the same coordinates as the texture coordinates for the texture map have separate coordinates.

If the same coordinates are shared by texture and normal maps, then the same UV coordinates can be shared without any edits. However, if new Normal coordinates are to be encoded, then the static mesh encoder would encode a separate normal coordinate using the same process as employed in encoding the UV coordinates for texture.

FIG. 9 illustrates Normal Encoding in Lossless mode. In the example of FIG. 9, V-DMC decoder 900 receives an input mesh frame and extracts a base mesh sub-bitstream (BMSB). Static mesh and normal attribute decoder 902 losslessly decodes the base mesh sub-bitstream to determine the connectivity of the mesh, the geometry, the UV coordinates, and the normal. V-DMC decoder 900 also extracts a texture mab sub-bitstream (TMSB) from the input mesh frame, and video decoder 904 decodes the texture map sub-bitstream to determine a 2D texture image. The 2D texture image may include a plurality of texture values, and the UV coordinates for the mesh may correspond to texture values in the image.

FIG. 10 illustrates Normal Encoding in Lossy intra mode. In the example of FIG. 10, V-DMC decoder 1000 receives an input mesh frame and extracts a base mesh sub-bitstream (BMSB). Static mesh and normal attribute decoder 1002 decodes the base mesh sub-bitstream to determine the connectivity of the base mesh, the geometry, the UV coordinates, and the normal. V-DMC decoder 1000 also extracts a displacement sub-bitstream (DSB) from the input mesh frame, and displacement decoder 1006 determines displacement vectors. V-DMC decoder 1000 then modifies the base mesh based on the displacements to determine a reconstructed deformed mesh. V-DMC decoder 1000 may also determine new normal values or modify already determined normal values based on the displacement vectors. V-DMC decoder 1000 also extracts a texture mab sub-bitstream (TMSB) from the input mesh frame, and video decoder 1004 decodes the texture map sub-bitstream to determine a 2D texture image. The 2D texture image may include a plurality of texture values, and the UV coordinates for the mesh may correspond to texture values in the image.

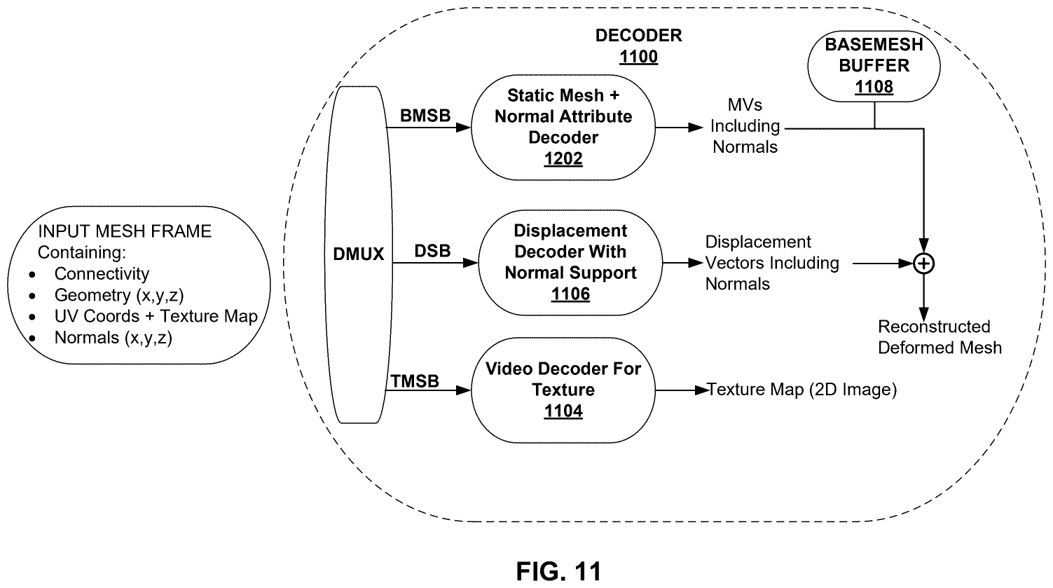

FIG. 11 illustrates Normal Encoding in Lossy inter mode. In the example of FIG. 11, V-DMC decoder 1100 receives an input mesh frame and extracts a base mesh sub-bitstream. Static mesh and normal attribute decoder 1002 decodes the base mesh sub-bitstream to determine motion vectors and, based on the motion vectors and decoded base meshes stored in base mesh buffer 1108, determines the connectivity of the base mesh, the geometry, the UV coordinates, and the normals. V-DMC decoder 1100 also extracts a displacement sub-bitstream (DSB) from the input mesh frame, and displacement decoder 1106 determines displacement vectors. V-DMC decoder 1100 then modifies the base mesh based on the displacement vectors to determine a reconstructed deformed mesh. V-DMC decoder 1100 may also determine new normal values or modify already determined normal values based on the displacement vectors. V-DMC decoder 1100 also extracts a texture mab sub-bitstream from the input mesh frame, and video decoder 1104 decodes the texture map sub-bitstream to determine a 2D texture image. The 2D texture image may include a plurality of texture values, and the UV coordinates for the mesh may correspond to texture values in the image.

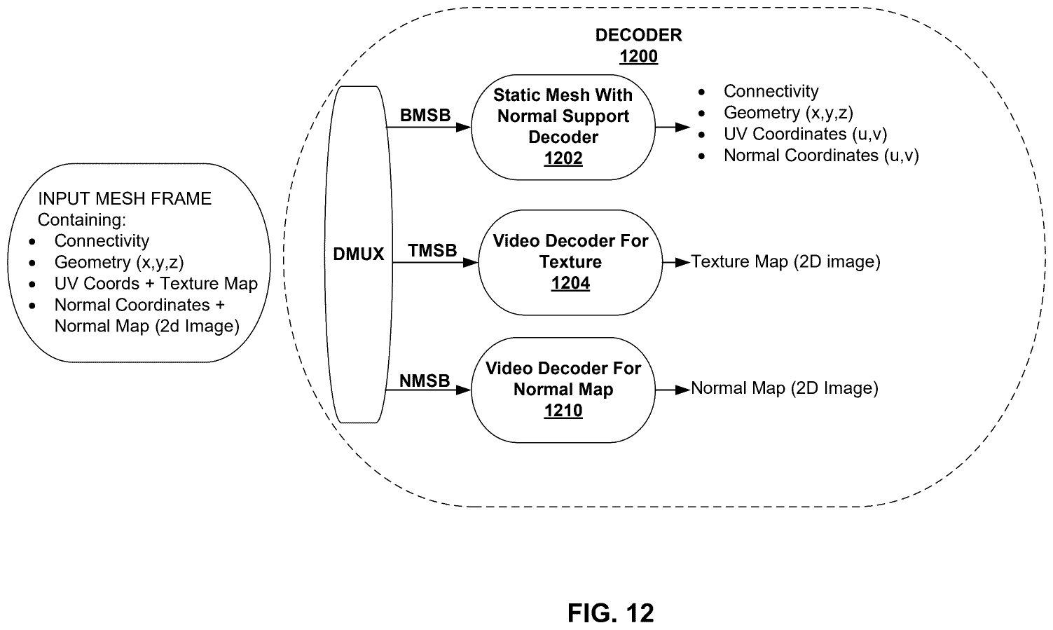

FIG. 12 illustrates Normal Map Encoding in lossless mode. In the example of FIG. 12, V-DMC decoder 1200 receives an input mesh frame and extracts a base mesh sub-bitstream. Static mesh and normal support decoder 1202 losslessly decodes the base mesh sub-bitstream to determine the connectivity of the mesh, the geometry, the UV coordinates, and the normal coordinates. V-DMC decoder 900 also extracts a texture mab sub-bitstream from the input mesh frame, and video decoder 904 decodes the texture map sub-bitstream to determine a 2D texture image. The 2D texture image may include a plurality of texture values, and the UV coordinates for the mesh may correspond to texture values in the image. V-DMC decoder 1200 also extracts a normal mab sub-bitstream (NMSB) from the input mesh frame, and video decoder 1210 decodes the normal map sub-bitstream to determine a 2D normal image. The 2D normals image may include a plurality of normals values, and the normals coordinates for the mesh may correspond to normal values in the image.

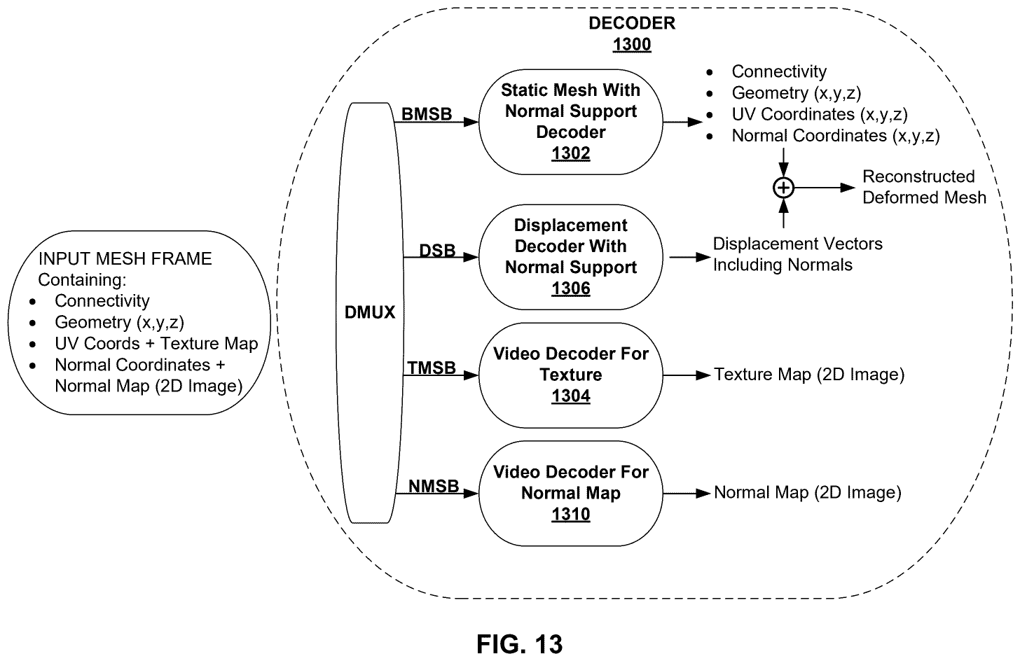

FIG. 13 illustrates Normal Map Encoding in lossy Intra mode. In the example of FIG. 13, V-DMC decoder 1300 receives an input mesh frame and extracts a base mesh sub-bitstream. Static mesh and normal attribute decoder 1302 decodes the base mesh sub-bitstream to determine the connectivity of the base mesh, the geometry, the UV coordinates, and the normal coordinates. V-DMC decoder 1300 also extracts a displacement sub-bitstream (DSB) from the input mesh frame, and displacement decoder 1306 determines displacement vectors. V-DMC decoder 13000 then modifies the base mesh based on the displacements to determine a reconstructed deformed mesh. V-DMC decoder 1300 may also determine new normal coordinates or modify already determined normal coordinates based on the displacement vectors. V-DMC decoder 1300 also extracts a texture mab sub-bitstream from the input mesh frame, and video decoder 1304 decodes the texture map sub-bitstream to determine a 2D texture image. The 2D texture image may include a plurality of texture values, and the UV coordinates for the mesh may correspond to texture values in the image. V-DMC decoder 1300 also extracts a normal mab sub-bitstream from the input mesh frame, and video decoder 1310 decodes the normal map sub-bitstream to determine a 2D normal image. The 2D normals image may include a plurality of normals values, and the normals coordinates for the mesh may correspond to normal values in the image.

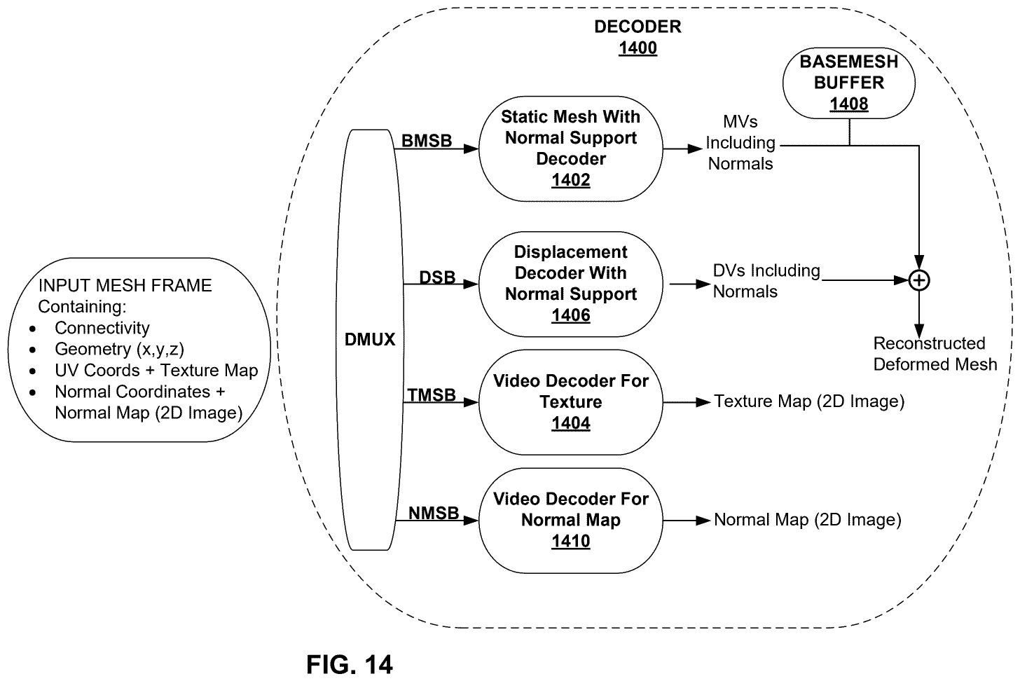

FIG. 14 illustrates Normal Map Encoding in lossy Inter mode. In the example of FIG. 14, V-DMC decoder 1400 receives an input mesh frame and extracts a base mesh sub-bitstream. Static mesh and normal attribute decoder 1402 decodes the base mesh sub-bitstream to determine motion vectors and, based on the motion vectors and decoded base meshes stored in base mesh buffer 1408, determines the connectivity of the base mesh, the geometry, the UV coordinates, and the normal coordinates. V-DMC decoder 1400 also extracts a displacement sub-bitstream from the input mesh frame, and displacement decoder 1406 determines displacement vectors. V-DMC decoder 1400 then modifies the base mesh based on the displacement vectors to determine a reconstructed deformed mesh. V-DMC decoder 1400 may also determine new normal values or modify already determined normal values based on the displacement vectors. V-DMC decoder 1400 also extracts a texture mab sub-bitstream from the input mesh frame, and video decoder 1404 decodes the texture map sub-bitstream to determine a 2D texture image. The 2D texture image may include a plurality of texture values, and the UV coordinates for the mesh may correspond to texture values in the image. V-DMC decoder 1400 also extracts a normal mab sub-bitstream from the input mesh frame, and video decoder 1410 decodes the normal map sub-bitstream to determine a 2D normal image. The 2D normals image may include a plurality of normals values, and the normals coordinates for the mesh may correspond to normal values in the image.

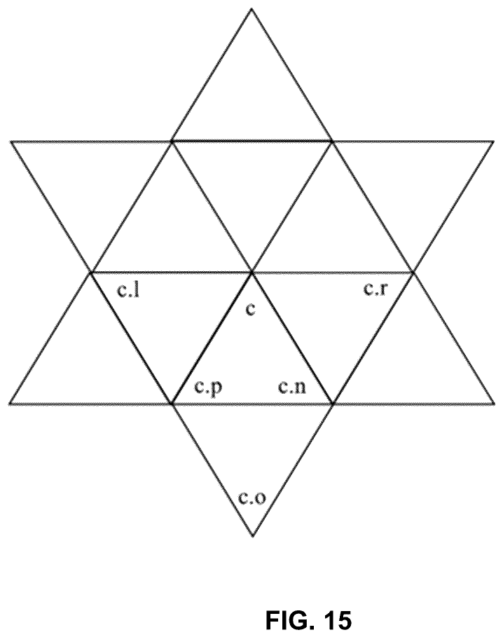

Aspects of static mesh with normal support will now be described. A Static Mesh encoder employs EdgeBreaker to encode the connectivity/topology of the base mesh and encodes the base mesh attributes (position, UV coordinates) using a prediction scheme as shown in FIGS. 8A and 8B. The attribute prediction scheme will be described in more detail with respect to FIG. 15. Adding a new attribute to the base mesh may include a new prediction scheme and follow the same process as shown in FIGS. 8A and 8B.

This disclosure describes multiple prediction schemes for static mesh encoding.

The prediction schemes used by the other attributes include min stretch prediction for UV coordinates (texture) and multi-parallelogram for position. Both these prediction schemes employ the corner table representation shown in FIG. 15. The disclosed prediction schemes may also employ the edge breaker's default corner table data representation.

FIG. 15 shows an example corner table representation. FIG. 15 uses the following abbreviations-current vertex (c), next vertex (c.n), previous vertex (c.p), opposite vertex (c.o). This order creates a fan around the current vertex c. FIG. 15 also shows a right corner (c.r) and a left corner (c.l).

Prediction schemes in accordance with the techniques of this disclosure will now be described. Multi-parallelogram prediction will now be described. The estimated normals are calculated by a lookup all around its vertex to calculate and aggregate each parallelogram prediction, utilizing opposite corners. All the parallelograms that have all the vertices already visited are used as a prediction and in the end the average of all the predictions is taken.

The formula for the estNorm for one parallelogram is:

$$estNorm = PrevNorm + NextNorm - OppositeNorm ;$$

TABLE 5
Normal Prediction: Multi-parallelogram.

```
  bool prevIsDummy = isCornerVertexDummy(OV.p(c));
  // search for some parallelogram estimations around the vertex of the corner
  int count = 0;
  int altC = c;
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC]))
    && (!isCornerVertexDummy(OV.p(altC)))
    && (!isCornerVertexDummy(OV.n(altC))))
    && ((M[V[O[altC]]] > 0) && (M[V[OV.p(altC)]] > 0) &&
  (M[V[OV.n(altC)]] > 0)))
    {
  // parallelogram prediction estNorm = prevNorm + nextNorm − oppoNorm
    glm::vec3 estNorm = Norm[V[OV.p(altC)]] + Norm[V[OV.n(altC)]] −
  Norm[V[O[altC]]];
    predNorm += estNorm; // accumulate parallelogram predictions
      ++count;
    }
  altC = OV.p(O[OV.p(altC)]); // swing around the triangle fan
  } while (altC != c);
  if (count > 0) // use parallelogram prediction when possible
  predNorm = glm::round(predNorm / glm::vec3(count)); // divide and round
each component of vector predPos
  else // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
  oNormals.push_back(Norm[V[c]] − predNorm); // store the residual = position −
predicted
```

### Additional Features for Multi-Parallelogram:

Version 7.0 TMM of V-DMC introduced the following improvements to the multi-parallelogram approach for normal predictions:
Perform predictions using the parallelogram around the current vertex (vertex whose normals are being predicted).
Go through the fan (FIG. 15) around the current vertex and use the parallelogram formed by c, c.n, c.p, and c.o (which is current, next, previous, and opposite vertices).
Use this parallelogram to predict the normal of the current vertex.
Take the average of all the multiple predictions from different parallelograms around the current vertex.
Normalize the prediction (to improve the predictions).
Scale the prediction to original scale/quantization (because that is lost after normalization).
Finally subtract the prediction from the original normal and store the residual (e.g., FIG. 11A).
If none of the parallelograms are available around the fan, then resort to delta coding by either taking the prediction as the previous vertex or the next vertex.
If the previous and next are not available, then the vertex could be on the boundary and the boundary neighboring vertex could be used as a prediction.
If none of these conditions satisfy, then the vertex could be the first vertex of the mesh and therefore, a global value of this vertex is stored rather than predicted.

A potentially improved implementation for multi-parallelogram for normals in v7.0 is shown in Table 5.1.

TABLE 5.1
Normal Prediction: Improved Multi-parallelogram in v7.0.

```
  const auto MAX_PARALLELOGRAMS = 4;
  const auto& ov = _ovTable;
  const auto& V = ov.V;
  const auto& O = ov.O;
  const auto& Norm = ov.normals;
  const auto& v = ov.v(c);
  // is vertex already predicted ?
  if (MV[v] > 0)
    return;
  // mark the vertex
  MV[v] = 1;
  // search for some parallelogram estimations around the vertex of the corner
  // the triangle fan might not be complete because of not using dummy points,
  // but known that a vertex is not non-manifold, so have only one fan per vertex
  // also some opposite might not be defined due to boundaries
  // use OV accessors and test to filter negative values
```

| | |
|---|---|
| glm::vec3 predNorm(0, 0, 0); | // the predicted normals |
| int count = 0; | // number of valid parallelograms found |

```
  int altC = c;
  // loop through corners attached to the current vertex
  // swing right around the fan
  int nextC = ov.n(O[ov.n(altC)]);
  while (nextC >= 0 && nextC != c)
  {
    altC = nextC;
    nextC = ov.n(O[ov.n(altC)]);
  };
  bool isBoundary = (nextC != c);
  // now positioned on the right most corner sharing v
  // turn left an evaluate the possible predictions
  const int startC = altC;
  do
  {
    if (count >= MAX_PARALLELOGRAMS) break;
    const auto& oppoV = ov.v(O[altC]);
    const auto& prevV = ov.v(ov.p(altC));
    const auto& nextV = ov.v(ov.n(altC));
    if ((oppoV > −1 && prevV > −1 && nextV > −1) &&
      ((MV[oppoV] > 0) && (MV[prevV] > 0) && (MV[nextV] > 0)))
    {
      // parallelogram prediction estNorm = prevNrm + nextNrm − oppoNrm
      glm::vec3 estNorm = Norm[prevV] + Norm[nextV] − Norm[oppoV];
```

| | |
|---|---|
| predNorm += estNorm; | // accumulate parallelogram |

```
predictions
      ++count;
    }
```

| | |
|---|---|
| altC = ov.p(O[ov.p(altC)]); | // swing around the triangle fan |
| } while (altC >= 0 && altC != startC); | // incomplete fan or full rotation |

```
  // 1. use parallelogram prediction when possible
  if (count > 0) {
    predNorm = glm::round(predNorm / glm::vec3(count));
    // center the prediction.
    const int32_t center = ( 1u << static_cast<uint32_t>( qn-1 ) );
    for (int c = 0; c < 3; c++) {
      predNorm[c] = predNorm[c] − center;
    }
    // normalize the prediction
    predNorm = glm::normalize( predNorm );
    if (!std::isnan( predNorm[0] ) ) {
      // Quantize the normals
```

| | |
|---|---|
| const glm::vec3 minNrm | = {−1.0, −1.0, −1.0}; |
| const glm::vec3 maxNrm | = {1.0, 1.0, 1.0}; |
| const glm::vec3 diag | = maxNrm − minNrm; |
| const float range | = std::max( std::max( diag.x, diag.y ), |

```
diag.z );
      const int32_t maxNormalQuantizedValue = ( 1u <<
static_cast<uint32_t>( qn ) ) − 1;
      for (int c = 0; c < 3; c++) {
        predNorm[c] = static_cast<float>(std::floor( ( ( predNorm[c] −
minNrm[c] ) / range ) * maxNormalQuantizedValue + 0.5f ) );
      }
      oNormals.push_back(Norm[v] − predNorm);
      oNrmFine.push_back(true);
      return;
    }
  }
    // 2. or fallback to delta with available values
  const auto& c_p_v = ov.v(ov.p(c));
  const auto& c_n_v = ov.v(ov.n(c));
  if (c_p_v > −1 && MV[c_p_v] > −1) {
    oNormals.push_back(Norm[v] − Norm[c_p_v]);
    oNrmFine.push_back(false);
    return;
  }
  if (c_n_v > −1 && MV[c_n_v] > −1) {
    oNormals.push_back(Norm[v] − Norm[c_n_v]);
    oNrmFine.push_back(false);
    return;
  }
  // 3. if on a boundary
  // then use deltas from previous vertex on the boundary
  if (isBoundary) {
    const auto b = ov.p(startC); // b is on boundary
    const auto b_v = ov.v(b);
    auto marked = MV[b_v];
    if (marked > −1) {
      oNormals.push_back(Norm[v] − Norm[b_v]);
      oNrmFine.push_back(false);
      return;
    }
  }
  // 4. no other choice
```

| | |
|---|---|
| osNormals.push_back(Norm[v]); | // global value (it is a start, pushed |

in separate table)

### Delta Coding (Process #2)

This process does not loop around the “fan” and does not make multiple estimates. Instead, this process only uses a single corner (previous or next). V-DMC encoder 200 checks the previous and/or next corner and estimates the difference between the previous and/or next vertex's normal and current vertex's normal and encode that difference.

$$\begin{matrix}estNorm = PrevNorm ; \\ EncodedNorm = estNorm - actualNorm ;\end{matrix}$$

TABLE 6
Normal Prediction: Delta Coding

oNormals.push_back(Norm[V[c]] - Norm[V[OV.p(c)]]);

Additional features for Multi-parallelogram prediction will now be described. v7.0 TMM of V-DMC introduced the following improvements to the multi-parallelogram approach for normal predictions:
Either take the prediction as the previous vertex's normal or the next vertex's normal.
If the previous and next are not available, then the vertex could be on the boundary and the boundary neighboring vertex could be used as a prediction.
If none of these conditions satisfy, then the vertex could be the first vertex of the mesh and therefore, V-DMC decoder 300 may store the global value of this vertex rather than predicting it.

The improved implementation for delta coding for normals in v7.0 TMM is shown in Table 6.1.

TABLE 6.1
Normal Prediction: Improvement to Delta Coding in v7.0 TMM

```
    const auto& ov = _ovTable;
    const auto& V = ov.V;
    const auto& O = ov.O;
    const auto& Norm = ov.normals;
    const auto& v = ov.v(c);
    // is vertex already predicted ?
    if (MV[v] > 0)
      return;
    // mark the vertex
    MV[v] = 1;
```

| | |
|---|---|
| oNrmFine.push_back(false); | // Always False for Delta |
| glm::vec3 predNorm(0, 0, 0); | // the predicted position |
| int count = 0; | // number of valid parallelograms found |

```
    int altC = c;
    // loop through corners attached to the current vertex
    // swing right around the fan
    int nextC = ov.n(O[ov.n(altC)]);
    while (nextC >= 0 && nextC != c)
    {
      altC = nextC;
      nextC = ov.n(O[ov.n(altC)]);
    };
    bool isBoundary = (nextC != c);
    // 1. Use delta with available values
    const auto& c_p_v = ov.v(ov.p(c));
    const auto& c_n_v = ov.v(ov.n(c));
    if (c_p_v > −1 && MV[c_p_v] > −1) {
      oNormals.push_back(Norm[v] − Norm[c_p_v]);
      return;
    }
    if (c_n_v > −1 && MV[c_n_v] > −1) {
      oNormals.push_back(Norm[v] − Norm[c_n_v]);
      return;
    }
    // 2. if on a boundary
    // then may use deltas from previous vertex on the boundary
    if (isBoundary) {
```

| | |
|---|---|
| const auto b = ov.p(altC); | // b is on boundary |

```
      const auto b_v = ov.v(b);
      auto marked = MV[b_v];
      if (marked > −1) {
        oNormals.push_back(Norm[v] − Norm[b_v]);
        return;
      }
    }
    // 3. no other choice
```

| | |
|---|---|
| osNormals.push_back(Norm[v]); | // global value (it is a start, pushed in |

separate table)

### Process #3

This process does not loop around the “fan” and does not make multiple estimates. Instead in this process, V-DMC decoder 300 uses the current triangle to take the average of the previous and next value.

TABLE 7
Normal Prediction: Process # 3

```
  bool prevIsDummy = isCornerVertexDummy(OV.p(c));
  glm::vec3 predNorm(0, 0, 0); // the predicted position
  if ((!isCornerVertexDummy(OV.p(c))) && (!isCornerVertexDummy(OV.n(c))
&& (M[V[OV.p(c)]] > 0) && (M[V[OV.n(c)]] > 0)){
  // Both previous and next are visited and not Dummies
  predNorm = ((Norm[V[OV.p(c)]] + Norm[V[OV.n(c)]]) / 2.0f);
  }else { // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
    }
  oNormals.push_back(Norm[V[c]] − predNorm); // store the residual = position −
predicted
```

### Process #4

In this process, V-DMC decoder 300 does not loop around the “fan” and does not make multiple estimates. Instead in this process, V-DMC decoder 300 uses the current triangle to take the average of three values: the previous, the next, and the opposite value.

TABLE 8
Normal Prediction: Process # 4

```
  bool prevIsDummy = isCornerVertexDummy(OV.p(c));
  glm::vec3 predNorm(0, 0, 0); // the predicted position
  if (((!isCornerVertexDummy(O[c])) && (!isCornerVertexDummy(OV.p(c)))
&& (!isCornerVertexDummy(OV.n(c)))) && ((M[V[O[c]]] > 0) && (M[V[OV.p(c)]] >
0) && (M[V[OV.n(c)]] > 0))) {
  // previous, next, and opposite are visited and not Dummies
  predNorm = ((Norm[V[OV.p(c)]] + Norm[V[OV.n(c)]] + Norm[V[O[c]]]) /
3.0f);
  }else {
  predNorm = prevIsDummy ? Norm[V[OV.n(c)]] : Norm[V[OV.p(c)]];
  }
  oNormals.push_back(Norm[V[c]] − predNorm); // store the residual = position −
predicted
```

### Process #5

In this process, V-DMC decoder 300 loops around the “fan” and makes multiple estimates. V-DMC decoder 300 uses the average of the previous and the next normal value to make estimates. In the end, V-DMC decoder 300 takes an average of all the estimates. Please note that as always, the estimates are only made if those vertices were previously visited.

TABLE 9
Normal Prediction: Process # 5

```
  bool prevIsDummy = isCornerVertexDummy(OV.p(c));
  // search for some parallelogram estimations around the vertex of the corner
  int count = 0;
  int altC = c;
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(OV.p(altC))) &&
!isCornerVertexDummy(OV.n(altC)))) && ((M[V[OV.p(altC)]] > 0) &&
(M[V[OV.n(altC)]] > 0)))
    {
    // parallelogram prediction estNorm = (prevNorm + nextNorm)/2
    glm::vec3 estNorm = ((Norm[V[OV.p(altC)]] + Norm[V[OV.n(altC)]]) /
  2.0f);
    predNorm += estNorm; // accumulate parallelogram predictions
    ++count;
  }
  altC = OV.p(O[OV.p(altC)]); // swing around the triangle fan
  } while (altC != c);
  if (count > 0) // use parallelogram prediction when possible
  predNorm = glm::round(predNorm / glm::vec3(count)); // divide and round
each component of vector predPos
  else // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
  oNormals.push_back(Norm[V[c]] − predNorm); // store the residual = position −
predicted
```

### Process #6

In this process, V-DMC decoder 300 loops around the “fan” and makes multiple estimates. V-DMC decoder 300 uses the average of the previous, the next, and the opposite normal value to make estimates. In the end, V-DMC decoder 300 takes an average of all the estimates. Please note that as always, the estimates are only made if those vertices were previously visited.

TABLE 10
Normal Prediction: Process # 6

```
  bool prevIsDummy = isCornerVertexDummy(OV.p(c));
  // search for some parallelogram estimations around the vertex of the corner
  int count = 0;
  int altC = c;
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]]] > 0) && (M[V[OV.p(altC)]] > 0) && (M[V[OV.n(altC)]] > 0)))
  {
  // parallelogram prediction estNorm = (prevNorm + nextNorm)/2
  glm::vec3 estNorm = ((Norm[V[OV.p(altC)]] + Norm[V[OV.n(altC)]] +
Norm[V[O[altC]]]) / 3.0f);
  predNorm += estNorm; // accumulate parallelogram predictions
  ++count;
  }
  altC = OV.p(O[OV.p(altC)]); // swing around the triangle fan
  } while (altC != c);
  if (count > 0) // use parallelogram prediction when possible
  predNorm = glm::round(predNorm / glm::vec3(count)); // divide and round
each component of vector predPos
  else // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
  oNormals.push_back(Norm[V[c]] − predNorm); // store the residual = position −
predicted
```

### Process #7

In this process, V-DMC decoder 300 does not loop around the “fan” and does not make multiple estimates. Instead in this process, V-DMC decoder 300 uses the current triangle.

V-DMC decoder 300 predicts the current vertex's normal using three values: the previous, the next, and the opposite value.

$$\begin{matrix}AvgTemp = ( PrevNorm + NextNorm ) / 2 ; \\ estNorm = AvgTemp - ( OppositeNorm - AvgTemp ) ;\end{matrix}$$

TABLE 11
Normal Prediction: Process # 7

```
  bool prevIsDummy = isCornerVertexDummy(OV.p(c));
  glm::vec3 predNorm(0, 0, 0); // the predicted position
  if (((!isCornerVertexDummy(O[c])) && (!isCornerVertexDummy(OV.p(c)))
&& (!isCornerVertexDummy(OV.n(c)))) && ((M[V[O[c]]] > 0) && (M[V[OV.p(c)]] >
0) && (M[V[OV.n(c)]] > 0))) {
  // previous, next, and opposite are visited and not Dummies
  glm::vec3 avgPN = ((Norm[V[OV.p(c)]] + Norm[V[OV.n(c)]]) / 2.0f);
  predNorm = avgPN − (Norm[V[O[c]]] − avgPN);
  }else { // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
  }
  oNormals.push_back(Norm[V[c]] − predNorm); // store the residual = position −
predicted
```

### Process #8

In this process, V-DMC decoder 300 repeats process #7 but across the whole fan. In this process, V-DMC decoder 300 loops around the “fan” and makes multiple estimates. In the end, V-DMC decoder 300 takes an average of all the estimates. Please note that as always, the estimates are only made if those vertices were previously visited.

The prediction process is the same as Process #7 but for all the parallelogram around the current corner's vertex.

$$\begin{matrix}AvgTemp = ( PrevNorm + NextNorm ) / 2 ; \\ estNorm = AvgTemp - ( OppositeNorm - AvgTemp ) ;\end{matrix}$$

This process is similar to the Process #0 because the above equation resolves to the same equation in Process #0.

TABLE 12
Normal Prediction: Process # 8

```
  bool prevIsDummy = isCornerVertexDummy(OV.p(c));
  // search for some parallelogram estimations around the vertex of the corner
  int count = 0;
  int altC = c;
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]] > 0) && (M[V[OV.p(altC)]] > 0) && (M[V[OV.n(altC)]] > 0)))
  {
  // parallelogram prediction estNorm = (prevNorm + nextNorm)/2
  glm::vec3 avgPN = ((Norm[V[OV.p(altC)] + Norm[V[OV.n(altC)]]) / 2.0f);
  glm::vec3 estNorm = avgPN − (Norm[V[O[altC]]] − avgPN);
  predNorm += estNorm; // accumulate parallelogram predictions
  ++count;
  }
  altC = OV.p(O[OV.p(altC)]); // swing around the triangle fan
  } while (altC != c);
  if (count > 0) // use parallelogram prediction when possible
  predNorm = glm::round(predNorm / glm::vec3(count)); // divide and round
each component of vector predPos
  else // or fallback to delta with available values
  // G[V[OV.n(c)]] cannot be dummy if prevIsDummy and is necessarily marked
  predNorm = prevIsDummy ? Norm[V[OV.n(c)]] : Norm[V[OV.p(c)]];
  oNormals.push_back(Norm[V[c] − predNorm); // store the residual = position −
predicted
```

### Inverse Distance Weighting (L1), Process #9

In this process, V-DMC decoder 300 loops around the “fan” and makes multiple estimates. In the end, V-DMC decoder 300 takes a weighted average of all the estimates. Please note that as always, the estimates are only made if those vertices were previously visited.

The estimation is made using inverse distance weight. The distance is calculated as L1 distance.

TABLE 13
Normal Prediction: Process # 9

```
  bool prevIsDummy = isCornerVertexDummy(OV.p(c));
  // search for some parallelogram estimations around the vertex of the corner
  int count = 0;
  int altC = c;
  double totalweight = 0;
  glm::vec3 numerator(0, 0, 0); // the predicted position
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]] > 0) && (M[V[OV.p(altC)]] > 0) && (M[V[OV.n(altC)]] > 0)))
  {
  // parallelogram prediction
  glm::vec3 avgPN = ((Norm[V[OV.p(altC)]] + Norm[V[OV.n(altC)]]) / 2.0f);
  glm::vec3 estNorm = avgPN − (Norm[V[O[altC]]] − avgPN);
  // store the distance weights
  glm::vec3 gPrev = G[V[OV.p(altC)]];
  glm::vec3 gNext = G[V[OV.n(altC)]];
  glm::vec3 gCurr = G[V[altC]];
  glm::vec3 gPgN_2 = ((gPrev + gNext) / 2.0f);
  glm::vec3 gPgN_2_gCurr = gCurr − gPgN_2;
  double d2_gPgN_2_gCurr = glm::dot(gPgN_2_gCurr, gPgN_2_gCurr);
  for (auto k = 0; k < 3; ++k) {
    numerator[k] += estNorm[k] / d2_gPgN_2_gCurr; }
  totalweight += 1 / d2_gPgN_2_gCurr;
  ++count;
    }
  altC = OV.p(O[OV.p(altC)]); // swing around the triangle fan
  } while (altC != c);
  if (count > 0) // use parallelogram prediction when possible
  for (auto k = 0; k < 3; ++k) {
    predNorm[k] = round(numerator[k] / totalweight);
  }
  else // or fallback to delta with available values
  predNorm = prevIsDummy ? Norm[V[OV.n(c)]] : Norm[V[OV.p(c)]];
  oNormals.push_back(Norm[V[c]] − predNorm); // store the residual = position −
predicted
```

### Inverse Distance Weighting (L2), Process #10

Same as Process #9 but the distance is calculated using L2 distance (mean square distance) instead of L1 distance.

TABLE 14
Normal Prediction: Process # 10

```
  bool prevIsDummy = isCornerVertexDummy(OV.p(c));
  // search for some parallelogram estimations around the vertex of the corner
  int count = 0;
  int altC = c;
  double totalweight = 0;
  glm::vec3 numerator(0, 0, 0); // the predicted position
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]]] > 0) && (M[V[OV.p(altC)]] > 0) && (M[V[OV.n(altC)]] > 0)))
  {
  // parallelogram prediction
  glm::vec3 avgPN = ((Norm[V[OV.p(altC)] + Norm[V[OV.n(altC)]]) / 2.0f);
  glm::vec3 estNorm = avgPN − (Norm[V[O[altC]]] − avgPN);
  // store the distance weights
  glm::vec3 gPrev = G[V[OV.p(altC)]];
  glm::vec3 gNext = G[V[OV.n(altC)]];
  glm::vec3 gCurr = G[V[altC]];
  glm::vec3 gPgN_2 = ((gPrev + gNext) / 2.0f);
  glm::vec3 gPgN_2_gCurr = gCurr − gPgN_2;
  double d2_gPgN_2_gCurr = std::sqrt(glm::dot(gPgN_2_gCurr,
gPgN_2_gCurr));
  for (auto k = 0; k < 3; ++k) {
    numerator[k] += estNorm[k] / d2_gPgN_2_gCurr; }
  totalweight += 1 / d2_gPgN_2_gCurr;
  ++count;
    }
  altC = OV.p(O[OV.p(altC)]); // swing around the triangle fan
  } while (altC != c);
  if (count > 0) // use parallelogram prediction when possible
  for (auto k = 0; k < 3; ++k) {
    predNorm[k] = round(numerator[k] / totalweight);
  }
  else // or fallback to delta with available values
  predNorm = prevIsDummy ? Norm[V[OV.n(c)] : Norm[V[OV.p(c)]];
  oNormals.push_back(Norm[V[c]] − predNorm); // store the residual = position −
predicted
```

### Process #11

In this process, V-DMC decoder 300 loops around the “fan” and make multiple estimates.

In this process, the estimates are the normal of the midpoint between the previous and the next vertex. Then, V-DMC decoder 300 chooses the estimate that is the closest distance to the current corner's vertex.

TABLE 15
Normal Prediction: Process # 11

```
  bool prevIsDummy = isCornerVertexDummy(OV.p(c));
  // search for some parallelogram estimations around the vertex of the corner
  int count = 0;
  int altC = c;
  double minDist = std::numeric_limits<double>::max( );
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]]] > 0) && (M[V[OV.p(altC)]] > 0) && (M[V[OV.n(altC)]] > 0)))
  {
  // parallelogram prediction
  glm::vec3 avgPN = ((Norm[V[OV.p(altC)]] + Norm[V[OV.n(altC)]]) / 2.0f);
  glm::vec3 estNorm = avgPN − (Norm[V[O[altC]]] − avgPN);
  // store the distance weights
  glm::vec3 gPrev = G[V[OV.p(altC)]];
  glm::vec3 gNext = G[V[OV.n(altC)]];
  glm::vec3 gCurr = G[V[altC]];
  glm:vec3 gPgN_2 = ((gPrev + gNext) / 2.0f);
  glm::vec3 gPgN_2_gCurr = gCurr − gPgN_2;
  double d2_gPgN_2_gCurr = std::sqrt(glm::dot(gPgN_2_gCurr,
gPgN_2_gCurr));
  if (d2_gPgN_2_gCurr < minDist) {
    minDist = d2_gPgN_2_gCurr;
    predNorm = estNorm;
    }
  ++count;
  }
  altC=OV.p(O[OV.p(altC)]); // swing around the triangle fan
  } while (altC != c);
  if (count > 0) { // use parallelogram prediction when possible
    ;}
  else // or fallback to delta with available values
  predNorm = prevIsDummy ? Norm[V[OV.n(c)] : Norm[V[OV.p(c)]];
  oNormals.push_back(Norm[V[c]] − predNorm); // store the residual = position −
predicted
```

### Process #12

In this process, V-DMC decoder 300 loops around the “fan” and estimate normals using the multi-parallelogram approach used in Process #1. However, instead of taking average of all the estimated normals, V-DMC decoder 300 chooses the estimate normal that was calculated from the triangle that has the closest opposite corner distance to the current corner's vertex.

TABLE 16
Normal Prediction: Process # 12

```
  bool prevIsDummy = isCornerVertexDummy(OV.p(c));
  // search for some parallelogram estimations around the vertex of the corner
  int count = 0;
  int altC = c;
  double minDist = std::numeric_limits<double>:max( );
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(O[altC])) &&
(!isCornerVertexDummy(OV.p(altC))) && (!isCornerVertexDummy(OV.n(altC))))
&& ((M[V[O[altC]]] > 0) && (M[V[OV.p(altC)]] > 0) && (M[V[OV.n(altC)]] > 0)))
  {
  // parallelogram prediction
  glm::vec3 avgPN = ((Norm[V[OV.p(altC)]] + Norm[V[OV.n(altC)]]) / 2.0f);
  glm::vec3 estNorm = avgPN − (Norm[V[O[altC]]] − avgPN);
  // store the distance weights
  glm::vec3 gO = G[V[O[altC]]];
  glm::vec3 gCurr = G[V[altC]];
  glm::vec3 gO_2_gCurr = gCurr − gO;
  double d2_gO_2_gCurr = std::sqrt(glm::dot(gO_2_gCurr, gO_2_gCurr));
  if (d2_gO_2_gCurr < minDist) {
    minDist = d2_gO_2_gCurr;
    predNorm = estNorm;
  }
  ++count;
  }
  altC = OV.p(O[OV.p(altC)]); // swing around the triangle fan
  } while (altC != c);
  if (count > 0) { // use parallelogram prediction when possible
  ;}
  else // or fallback to delta with available values
  predNorm = prevIsDummy ? Norm[V[OV.n(c)] : Norm[V[OV.p(c)]];
  oNormals.push_back(Norm[V[c]] − predNorm); // store the residual = position −
predicted
```

### Process #13

In this process, V-DMC decoder 300 loops around the “fan” and chooses the normal of the vertex that is closes to the current corner's vertex. V-DMC decoder 300 may only consider the previous and next corner's vertex in each parallelogram since those corners would be the closest to the current corner's vertex.

TABLE 17
Normal Prediction: Process # 13

```
  bool prevIsDummy = isCornerVertexDummy(OV.p(c));
  // search for some parallelogram estimations around the vertex of the corner
  int count = 0;
  int altC = c;
  double minDist = std::numeric_limits<double>:max( );
  glm::vec3 predNorm(0, 0, 0); // the predicted position
  do // loop through corners attached to the current vertex
  {
  if (count >= MAX_PARALLELOGRAMS) break;
  if (((!isCornerVertexDummy(OV.p(altC))) &&
(!isCornerVertexDummy(OV.n(altC)))) && ((M[V[OV.p(altC)]] > 0) &&
(M[V[OV.n(altC)]] > 0)))
  {
  // Calculate the distances
  glm::vec3 gPrev = G[V[OV.p(altC)]];
  glm::vec3 gNext = G[V[OV.n(altC)]];
  glm::vec3 gCurr = G[V[altC]];
  glm::vec3 gPrev_2_gCurr = gCurr − gPrev;
  double d2_gPrev_2_gCurr = std::sqrt(glm::dot(gPrev_2_gCurr,
gPrev_2_gCurr));
  glm::vec3 gNext_2_gCurr = gCurr − gNext;
  double d2_gNext_2_gCurr = std::sqrt(glm::dot(gNext_2_gCurr,
gNext_2_gCurr));
  if (d2_gPrev_2_gCurr < d2_gNext_2_gCurr) {
  if (d2_gPrev_2_gCurr < minDist) {
    minDist = d2_gPrev_2_gCurr;
    predNorm = Norm[V[OV.p(altC)]];
    }
  } else {
  if (d2_gNext_2_gCurr < minDist) {
    minDist = d2_gNext_2_gCurr;
    predNorm = Norm[V[OV.n(altC)]];
  }
  }
  ++count;
  }
  altC = OV.p(O[OV.p(altC)]); // swing around the triangle fan
  } while (altC != c);
  if (count > 0) { // use parallelogram prediction when possible
  ;}
  else // or fallback to delta with available values
  predNorm = prevIsDummy ? Norm[V[OV.n(c)]] : Norm[V[OV.p(c)]];
  oNormals.push_back(Norm[V[c]] − predNorm); // store the residual = position −
predicted
```

### Process #14

In this process, V-DMC decoder 300 employs the minimum stretch process that is being employed in the UV coordinate prediction in texture attribute coding. This process is shown in Tables 3 and 4. V-DMC decoder 300 may use the same technique but use the normals instead of the UV coordinates.

### Process #15

In this process, V-DMC decoder 300 estimates the current corner's vertex using the previous, next and opposite corner's normals.
We find the line (PN) joining previous (P) and next (N)
We find the line (OC) joining previous (O) and next (C)
We find the point (M) that the lines PN and OC intersect on.
We then estimate the normal on the point M (NormMid)
We predict the EstNorm of the point O using the NormMid using the parallelogram prediction in process #1.

$$estNorm = NormMid + NormPrev - NormOpposite ;$$

We can do this process for a single parallelogram or go around the “fan” and do multi-parallelogram approach for prediction and then taking average.

### Process #16

In this process, V-DMC decoder 300 may not just employ the previous and next corners but also the left and right corners. V-DMC decoder 300 may do this process for a single parallelogram or go around the “fan” and do multi-parallelogram approach for prediction and then taking average.

### Learning-Based Prediction, Process #17

In this process, V-DMC decoder 300 may employ a deep learning model and/or use the neighboring as well as the previously visited and/or decoded vertices to predict the normal of the current vertex.

This constitutes a learning-based prediction scheme.

Geometry-based Cross product Normal Estimation, Process #18—This process uses the geometry to predict the normal of the current corner's vertex.

This process employs the geometry from the previous, next, and current vertex to predict the normal of the current vertex. V-DMC decoder 300 may find the vector between previous and current vertex and find another vertex between next and current vertex. Then, V-DMC decoder 300 may do a cross product between these two vertices to obtain the normal of the current vertex.

The prediction scheme for normal of the current vertex includes calculating the vectors between previous and current, and next and current vertex using the geometry. Then, V-DMC decoder 300 may do a cross product to find the normal.

$$\begin{matrix}constglm \text{::} vec 3 v 12 = G [ V [ O V . p ( c ) ] ] - G [ V [ c ] ] ; \\ constglm \text{::} vec 3 v 13 = G [ V [ O V . n ( c ) ] ] - G [ V [ c ] ] ; \\ glm \text{::} v ec 3 normal = glm \text{::} cross ( v 13 , v 12 ) ;\end{matrix}$$

Due to predicting the normal based on vectors from geometry, the direction of the normals can be in two directions based on the cross product of the two vectors, i.e., “cross (v12, v13)” or “cross (v13,v12)”. V-DMC decoder 300 may additionally send the order of the cross product and/or the direction of the normal as a side information for solutions with cross product.

TABLE 18
Normal prediction using cross-product. Process # 18.

```
  bool prevIsDummy = isCornerVertexDummy(OV.p(c));
  glm::vec3 predNorm(0, 0, 0);
  if (((!isCornerVertexDummy(OV.p(c))) &&
(!isCornerVertexDummy(OV.n(c)))) && ((M[V[OV.p(c)]] > 0) && (M[V[OV.n(c)]] >
0)))
  {
  const glm::vec3 v12 = G[V[OV.p(c)]] − G[V[c]];
  const glm::vec3 v13 = G[V[OV.n(c)]] − G[V[c]];
  glm::vec3 normal = glm::cross( v13, v12 );
  normal = glm::normalize(normal);
  if ( std::isnan( normal[0] ) ) {
    break;
  }
  // Quantize the normal
  const glm::vec3 diag = cfg.maxNrm − cfg.minNrm;
  const float range = std::max( std::max( diag.x, diag.y ), diag.z );
  const int32_t maxNormalQuantizedValue = (1u<<static_cast<uint32_t>(qn)) −
1;
  for (int c = 0; c < 3; c++) {
    predNorm[c] = static_cast<uint32_t>(std::floor( ( ( normal[c] −
  cfg.minNrm[c] ) / range ) * maxNormalQuantizedValue + 0.5f ) );
    }
  } else {
    predNorm = prevIsDummy ? Norm[V[OV.n(c)]] : Norm[V[OV.p(c)]];
  }
  oNormals.push_back(Norm[V[c] − predNorm); // store the residual = position −
predicted
```

Average of Cross product for Normal Estimation, Process #19—Process #19 represents a potential modification to Process #18.

Rather than having a single prediction using cross product as in Process #18, in Process #19, V-DMC decoder 300 may do multiple predictions from all the available triangles around the current vertex. Then, V-DMC decoder 300 may take an average of these predictions. Since the cross product is calculated during geometry encoding in EdgeBreaker, this process may be referred to as “CrossproductEB”.

As a result of predicting the normal based on vectors from geometry, the direction of the normals can be in two directions based on the cross product of the two vectors, i.e., “cross (v12, v13)” or “cross (v13,v12)”. V-DMC decoder 300 may additionally send the order of the cross product and/or the direction of the normal as a side information for solutions with cross product.

TABLE 19
Normal prediction using multiple cross-product. Process # 19.

```
  bool prevIsDummy = isCornerVertexDummy(OV.p(c));
  glm::vec3 predNorm(0, 0, 0);
  if (((!isCornerVertexDummy(OV.p(c))) &&
(!isCornerVertexDummy(OV.n(c)))) && ((M[V[OV.p(c)]] > 0) && (M[V[OV.n(c)]] >
0)))
  {
  const glm::vec3 v12 = G[V[OV.p(c)]] − G[V[c]];
  const glm::vec3 v13 = G[V[OV.n(c)]] − G[V[c]];
  glm::vec3 normal = glm::cross( v13, v12 );
  normal = glm::normalize(normal);
  if ( std::isnan( normal[0] ) ) {
    break;
  }
  // Quantize the normal
  const glm::vec3 diag = cfg.maxNrm − cfg.minNrm;
  const float range = std::max( std::max( diag.x, diag.y ), diag.z );
  const int32_t maxNormalQuantizedValue = (1u<<static_cast<uint32_t>(qn)) −
1;
  for (int c = 0; c < 3; c++) {
    predNorm[c] = static_cast<uint32_t>(std::floor( ( ( normal[c] −
  cfg.minNrm[c] ) / range ) * maxNormalQuantizedValue + 0.5f ) );
    }
  } else {
    predNorm = prevIsDummy ? Norm[V[OV.n(c)]] : Norm[V[OV.p(c)]];
  }
  oNormals.push_back(Norm[V[c] − predNorm); // store the residual = position −
predicted
```

Cross Product after the Geometry Compression is Completed. Process #20

Rather than predicting and encoding the normals during EdgeBreaker encoding of the geometry, in this process, V-DMC encoder 200 may first encode the geometry. Once the geometry is encoded for all the vertices, then V-DMC encoder 200 may use this geometry to calculate the normals using cross-product of all the triangles around the current corner's vertex. Since the geometry is already encoded, V-DMC encoder 200 may use all the triangles around to predict the current vertex's normal. This gives the best result because all of geometry can be employed to predict the normals rather than only the decoded/encoded geometry. This process may be referred to as “Crossproduct Global.”

Due to predicting the normal based on vectors from geometry, the direction of the normals may be in two directions based on the cross product of the two vectors, i.e., “cross (v12, v13)” or “cross (v13,v12)”. V-DMC encoder 200 may additionally send the order of the cross product and/or the direction of the normal as a side information for solutions with cross product.

TABLE 20
Normal Prediction using cross product after the geometry compression.
“Crossproduct Global”, Process #20

```
  // Predict the normals from Geometry
  eb::Model ebModelNorm;
  ModelConverter::convertCTMeshToModel(_ovTable, ebModelNorm);
  ebModelNorm.normals.clear( );
  ebModelNorm.computeVertexNormals(true, true);
  // Quantize normals
  const glm::vec3 diag = cfg.maxNrm − cfg.minNrm;
  const float range = std::max( std::max( diag.x, diag.y ), diag.z );
  const int32_t maxNormalQuantizedValue = (1u << static_cast<uint32_t>(qn) ) −
1;
  for ( size_t i = 0; i < ebModelNorm.normals.size( ) / 3; i++ ) {
  for ( glm::vec3::length_type c = 0; c < 3; ++c ) {
    uint32_t nrm = static_cast<uint32_t>(
    std::floor( ( ( ebModelNorm.normals[i * 3 + c] − cfg.minNrm[c] ) / range
  ) * maxNormalQuantizedValue + 0.5f ) );
    ebModelNorm.normals[i * 3 + c] = static_cast<float>( nrm );
  }
  }
  CTMesh _ovTablePredNorm;
  ModelConverter::convertModelToCTMesh(ebModelNorm, _ovTablePredNorm,
cfg.deduplicate);
  // Store the predicted normals
  const auto& Norm = _ovTable.normals;
  const auto& V = _ovTable.V;
  for (auto i = 0; i < cTraverse.size( ); ++i) {
  int c = cTraverse[i];
  oNormals.push_back(Norm[V[c] − _ovTablePredNorm.normals[V[c]]);
```

Normal Prediction Using Projection of Opposite and Current. Process #21

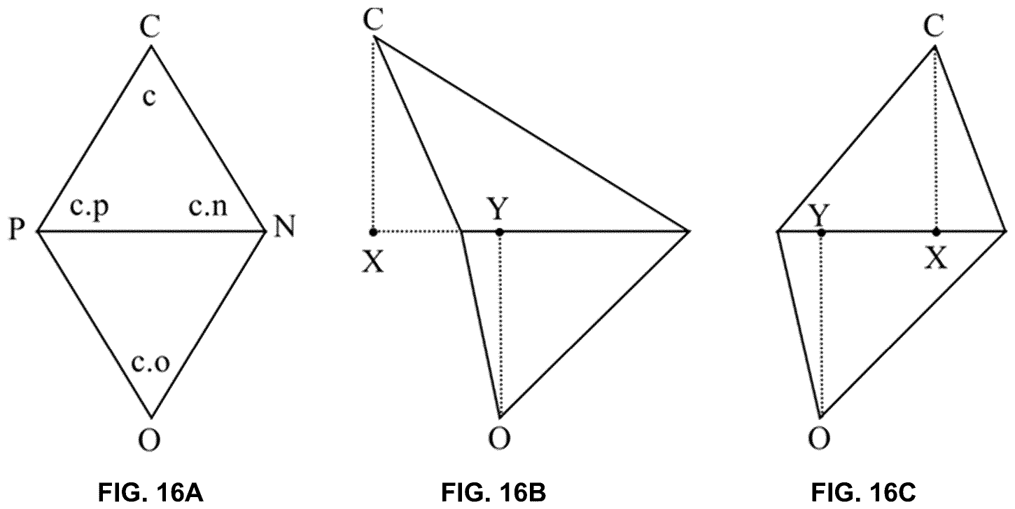

FIGS. 16A-16C show examples of normal predictions. FIG. 16A shows an example using a previous vertex (P), next vertex (N), and opposite vertex (O) to predict the current vertex C. FIG. 16A show different vertices that can be used to predict the current vertex's (C) normal. Normally (as shown in the previous processes), V-DMC decoder 300 may employ a combination of P, N, and O vertex to predict the normal at C. V-DMC decoder 300 may employ the normals and/or the geometry of the neighboring vertices (P,N,O) to predict the current vertex's normals.

However, in process #21, V-DMC decoder 300 may use arbitrary (or dummy vertices) X and Y, as shown in FIGS. 16B and 16C. X and Y are vertices generated by the projection of vertex C and O on the PN plane.

V-DMC decoder 300 may take the distance-based weighted average of the normals at P and N to get the normals at X and Y.

Then, V-DMC decoder 300 may use a combination of normals at X, Y, and O to obtain the normals at C.

One combination of such prediction could be:

$$norm C = normX + normY - normC$$

This equation is like multi-parallelogram in Process #1. However, rather than using P and N vertices, V-DMC decoder 300 may employ X and Y vertices.

Similarly, V-DMC decoder 300 may do this for one triangle or go around the “fan” of the vertex and do multiple predictions from different triangles/parallelograms and then take the average of it.

### Other Processes

We can use different combinations of vertices around the current vertex and use their normals, geometry, and/or UV coordinates to predict the current vertex's Normal.

The vertices and/or corners around the current vertex may be employed. The attributes of these neighbors may be employed to predict the current vertex's normal. These attributes may include geometry, uv-coordinates, normals, etc.

### Update to the Cross Product-Based Processes.

v7.0 TMM of V-DMC introduced the following potential improvements to the cross product-based normal predictions:
In v7.0 TMM V-DMC, the normals are predicted after the encoding/decoding of the geometry. This entails that the geometry for all the vertices are available to be used for the prediction of normals.
All the available triangles around the current vertex are used to predict the normal of the current vertex.
Go through the fan (FIG. 15) around the current vertex and use the geometry of the vertices: c, c.n, and c.p (current vertex, next vertex, and previous vertex) to predict the face normals.
Take the average of all the face normals around the current vertex (in the fan).
Please note that unlike other prediction schemes, cross product-based predictions uses the geometry of the vertices to predict the normals. While in the previous methods, the previously encoded/visited normals are employed to predict the current vertex's normal.
If the geometry of all triangles around the current vertex are not available, then fall back to delta coding. In this case the normal from either the previous or the next vertex would be used as prediction.
If the previous and next are not available, then the vertex could be on the boundary and the boundary neighboring vertex could be used as a prediction.
If none of these conditions satisfy, then the vertex could be the first vertex of the mesh and therefore, V-DMC decoder 300 may store the global value of this vertex rather than predicting it.

The code for this implementation is shown in Table 21.

TABLE 21
Normal Prediction: Improved cross product
based normal prediction in v7.0

```
  const auto& ov =_ovTable;
  const auto& V = ov.V;
  const auto& O = ov.O;
  const auto& Norm = ov.normals;
  const auto& G = ov.positions;
  const auto& v = ov.v(c);
  // is vertex already predicted ?
  if (MV[v] > 0)
    return;
  // mark the vertex
  MV[v] = 1;
  glm::vec3 predNorm(0, 0, 0); // the predicted normals
  int count = 0; // number of valid parallelograms found
  int altC = c;
  // loop through corners attached to the current vertex
  // swing right around the fan
  int nextC = ov.n(O[ov.n(altC)]);
  while (nextC >= 0 && nextC != c)
  {
    altC = nextC;
    nextC = ov.n(O[ov.n(altC)]);
  };
  bool isBoundary = (nextC != c);
  // now positioned on the right most corner sharing v
  // turn left an evaluate the possible predictions
  const int startC = altC;
  do
  {
    const auto& prevV = ov.v(ov.p(altC));
    const auto& nextV = ov.v(ov.n(altC));
    /*if ((prevV > −1 && nextV > −1) &&
      ((MV[prevV] > 0) && (MV[nextV] > 0)))*/
    if (prevV > −1 && nextV > −1)
    {
      const glm::vec3 v12 = G[prevV] − G[v];
      const glm::vec3 v13 = G[nextV] − G[v];
      predNorm += glm::cross( v13, v12);
      ++count;
    }
    altC = ov.p(O[ov.p(altC)]); // swing around the triangle fan
  } while (altC >= 0 && altC != startC); // incomplete fan or full
  rotation
  // 1. use cross products
  if (count > 0) {
    // normalize the prediction
    predNorm = glm::normalize( predNorm );
    if (!std::isnan( predNorm[0] ) ) {
      // Quantize the normals
      const glm::vec3 minNrm = {−1.0, −1.0, −1.0};
      const glm::vec3 maxNrm = {1.0, 1.0, 1.0};
      const glm::vec3 diag = maxNrm − minNrm;
      const float range = std::max( std::max( diag.x, diag.y ), diag.z
);
      const int32_t maxNormalQuantizedValue = ( 1u <<
static_cast<uint32_t>(qn) ) − 1;
      for (int c = 0; c < 3; c++) {
        predNorm[c] = static_cast<float>(std::floor( ( ( predNorm[c] −
minNrm[c] ) / range ) * maxNormalQuantizedValue + 0.5f ) );
      }
      oNormals.push_back(Norm[v] − predNorm);
      oNrmFine.push_back(true);
      return;
    }
  }
  // 2. or fallback to delta with available values
  const auto& c_p_v = ov.v(ov.p(c));
  const auto& c_n_v = ov.v(ov.n(c));
  if (c_p_v > −1 && MV[c_p_v] > −1) {
    oNormals.push_back(Norm[v] − Norm[c_p_v]);
    oNrmFine.push_back(false);
    return;
  }
  if (c_n_v > −1 && MV[c_n_v] > −1) {
    oNormals.push_back(Norm[v] − Norm[c_n_v]);
    oNrmFine.push_back(false);
    return;
  }
  // 3. if on a boundary
  // then may use deltas from previous vertex on the boundary
  if (isBoundary) {
    const auto b = ov.p(startC); // b is on boundary
    const auto b_v = ov.v(b);
    auto marked = MV[b_v];
    if (marked > −1) {
      oNormals.push_back(Norm[v] − Norm[b_v]);
      oNrmFine.push_back(false);
      return;
    }
  }
  // 4. no other choice
  osNormals.push_back(Norm[v]); // global value (it is a start,
pushed in separate table)
```

### Additions to the Syntax of the V-DMC

These are the syntax elements in V3C parameters (see U.S. Provisional Patent Application 63/621,478) and the base mesh syntax and semantics that were employed for the normal encoding.

Syntax used for implementing the techniques of this disclosure is indicated between the delimiters <**> and </**>.

### H.8.1.3.1.1 General Base Mesh Sequence Parameter Set RBSP Syntax

| | Descriptor |
|---|---|
| bmesh_sequence_parameter_set_rbsp( ) { | |
| bmsps_sequence_parameter_set_id | u(4) |
| bmesh_profile_tier_level( ) | |
| bmsps_intra_mesh_codec_id | u(8) |
| bmsps_inter_mesh_codec_id | u(8) |
| bmsps_geometry_3d_bit_depth_minus1 | u(5) |
| bmsps_inter_mesh_max_num_mvp_cand_minus1 | u(2) |
| <**>bmsps_mesh_attribute_count</**> | u(7) |
| for( i = 0; i < bmsps_mesh_attribute_count; i++ ) { | |
| bmsps_mesh_attribute_index[ i ] | u(8) |
| <**>bmsps_mesh_attribute_type_id[ i ] </**> | u(4) |
| <**>bmsps_attribute_bit_depth_minus1[ i ] </**> | u(5) |
| bmsps_attribute_msb_align_flag[ i ] | u(1) |
| } | |
| bmsps_intra_mesh_post_reindex_method | ue(v) |
| bmsps_log2_max_mesh_frame_order_cnt_lsb_minus4 | ue(v) |
| bmsps_max_dec_mesh_frame_buffering_minus1 | ue(v) |
| bmsps_long_term_ref_mesh_frames_flag | u(1) |
| bmsps_num_ref_mesh_frame_lists_in_bmsps | ue(v) |
| for( i = 0; i < bmsps_num_ref_mesh_frame_lists_in_bmsps; i+ | |
| + ) | |
| bmesh_ref_list_struct( i ) | |
| bmsps_inter_mesh_motion_group_size_minus1 | ue(v) |
| bmsps_inter_mesh_max_num_neighbours_minus1 | ue(v) |
| bmsps_extension_present_flag | u(1) |
| if( bmsps_extension_present_flag ) { | |
| bmsps_extension_count | u(8) |
| } | |
| if( bmsps_extension_count ){ | |
| bmsps_extensions_length_minus1 | ue(v) |
| for( i = 0; i < bmsps_extension_count; i++ ) { | |
| bmsps_extension_type[ i ] | u(8) |
| bmsps_extension_length[ i ] | u(16) |
| bmsps_extension( bmsps_extension_type[ i ], | |
| bmsps_extension_length[ i ] ) | |
| } | |
| } | |
| rbsp_trailing_bits( ) | |
| } | |

TABLE H-2
(see U.S. Provisional Patent Application 63/621,478)

| bmsps_mesh_{—} | | |
|---|---|---|
| attribute_{—} | | Attribute |
| type_id[ i ] | Identifier | type |
| 0 | ATTR_TEXTURE | Texture |
| 1 | ATTR_MATERIAL_ID | Material ID |
| 2 | ATTR_TRANSPARENCY | Transparency |
| 3 | ATTR_REFLECTANCE | Reflectance |
| <**>4</**> | <**>ATTR_NORMAL</**> | <**>Normals</**> |
| 5 | ATTR_FACEGROUP_ID | Facegroup ID |
| 6 . . . 14 | ATTR_RESERVED | Reserved |
| 15 | ATTR_UNSPECIFIED | Unspecified |

### 8.3.4.5 Attribute Information Syntax

| | Descriptor |
|---|---|
| attribute_information( atlasID ) { | |
| <**>ai_attribute_count[ atlasID ] </**> | u(7) |
| for( i = 0; i < ai_attribute_count[ atlasID ]; i++ ) { | |
| <**>ai_attribute_type_id[ atlasID ][ i ] </**> | u(4) |
| <**>ai_attribute_codec_id[ atlasID ][ i ] </**> | u(8) |
| if( vps_auxiliary_video_present_flag[ atlasID ] ) | |
| ai_auxiliary_attribute_codec_id[ atlasID ][ i ] | u(8) |
| if( vps_map_count_minus1[ atlasID ] > 0 ) | |
| ai_attribute_map_absolute_coding_persistence_flag[ atlasID | u(1) |
| ][ i ] | |
| ai_attribute_dimension_minus1[ atlasID ][ i ] | u(6) |
| if( ai_attribute_dimension_minus1[ atlasID ][ i ] > 0 ) { | |
| ai_attribute_dimension_partitions_minus1 [ atlasID ][ i ] | u(6) |
| remainingDimensions = ai_attribute_dimension_minus1[ atlasI | |
| D ][ i ] | |
| k = ai_attribute_dimension_partitions_minus1 [ atlasID ][ i ] | |
| for( j = 0; j < k; j++ ) { | |
| if( k − j == remainingDimensions ) | |
| ai_attribute_partition_channels_minus1[ atlasID ][ i ][ j ] = 0 | |
| else | |
| ai_attribute_partition_channels_minus1[ atlasID ][ i ][ j ] | ue(v) |
| remainingDimensions −= | |
| ai_attribute_partition_channels_minus1 [ atlasID ][ i ][ j ] + 1 | |
| } | |
| ai_attribute_partition_channels_minus1 [ atlasID ][ i ][ k ] = rem | |
| ainingDimensions | |
| } | |
| ai_attribute_2d_bit_depth_minus1[ atlasID ][ i ] | u(5) |
| ai_attribute_MSB_align_flag[ atlasID ][ i ] | u(1) |
| } | |
| } | |

### Base Mesh Encoder Syntax:

### I.8.3.2 Mesh Coding Header Syntax

| | Descriptor |
|---|---|
| mesh_coding_header( ) { | |
| mesh_codec_type | u(2) |
| mesh_vertex_traversal_method | ue(v) |
| mesh_position_encoding_parameters( ) | |
| mesh_position_dequantize_flag | u(1) |
| if (mesh_position_dequantize_flag ) | |
| mesh_position_dequantize_parameters( ) | |
| <**>mesh_attribute_count</**> | u(5) |
| for( i=0; i<mesh_attribute_count; i++ ){ | |
| <**>mesh_attribute_type[ i] </**> | u(3) |
| if( mesh_attribute_type[ i ] == MESH_ATTR_TEXCOORD ) | |
| NumComponents[ i ] = 2 | |
| <**>else | |
| if( mesh_attribute_type[ i ] == MESH_ATTR_NORMAL ) </**> | |
| <**>NumComponents[ i ] = 3</**> | |
| else | |
| if( mesh_attribute_type[ i ] == MESH_ATTR_COLOR ) | |
| NumComponents[ i ] = 3 | |
| else if( mesh_attribute_type[ i ] == MATERIAL_ID ) | |
| NumComponents[ i ] = 1 | |
| else if( mesh_attribute_type[ i ] == GENERIC ) { | |
| mesh_attribute_num_components_minus1[ i ] | u(2) |
| NumComponents[ i ] = mesh_attribute_num_components_minu | |
| s1[ i ]+1 | |
| } | |
| mesh_attribute_encoding_parameters ( i ) | |
| <**>mesh_attribute_dequantize_flag[ i ] </**> | u(1) |
| if (mesh_attribute_dequantize_flag[ i ] ) | |
| mesh_attribute_dequantize_parameters ( i ) | |
| } | |
| length_alignment( ) | |
| } | |

### I.8.3.5 Mesh Attributes Encoding Parameters Syntax

| | De- |
|---|---|
| | scriptor |
| mesh_attribute_encoding_parameters( index ) { | |
| <**>mesh_attribute_bit_depth_minus1[ index ] </**> | u(4) |
| <**>mesh_attribute_per_face_flag[ index ] </**> | u(1) |
| if( !mesh_attribute_per_face_flag[ index ] ) { | |
| <**>mesh_attribute_separate_index_flag[ index ] | u(1) |
| </**> | |
| if( !mesh_attribute_separate_index_flag[ index ] ) | |
| <*>mesh_attribute_reference_index_plus1[ index ] | ue(v) |
| </**> | |
| } | |
| <**>mesh_attribute_prediction_method[ index ] </**> | ue(v) |
| <**>mesh_attribute_residuals_encoding_method [ | ue(v) |
| index ] </**> | |
| } | |

### I.8.3.5 Mesh Attributes Dequantize Parameters Syntax

| | Descriptor |
|---|---|
| mesh_attribute_dequantize_parameters( index ) { | |
| for( j=0; j < NumComponents[ index ]; j++ ){ | |
| <**>mesh_attribute_min[ index ][ j ] </**> | fl(32) |
| <**>mesh_attribute_max[ index ][ j ] </**> | fl(32) |
| } | |
| } | |

### Older Table:

TABLE I-10
Mesh attribute prediction processes for
MESH_ATTR_NORMAL type attributes

| mesh_attribute_{—} | | Prediction |
|---|---|---|
| prediction_method[ i ] | Identifier | Process |
| 0 | MESH_NORMAL_DEFAULT | Default |
| | | (TODO) |
| >0 | MESH_NORMAL_RESERVED | Reserved |

### Updated Proposed Table

Four prediction schemes are described in this next section, which are as follows:
Process #2: MESH_NORMAL_DELTA
Process #1: MESH_NORMAL_MPARA
Process #19: MESH_NORMAL_CROSSEB
Process #20: MESH_NORMAL_CROSSGL

These are also explained in the section before. The updated table is shown ahead:

TABLE I-10
Mesh attribute prediction processes for
MESH_ATTR_NORMAL type attributes

| mesh_attribute_{—} | | Prediction |
|---|---|---|
| prediction_method[ i ] | Identifier | Process |
| 0 | MESH_NORMAL_DELTA | Delta |
| | | (Process # 2) |
| 1 | MESH_NORMAL_MPARA | Multi- |
| | | parallelogram |
| | | (Process # 1) |
| 2 | MESH_NORMAL_CROSSEB | Cross product |
| | | during |
| | | EdgeBreaker |
| | | (Process # 19) |
| 3 | MESH_NORMAL_CROSSGL | Cross product |
| | | global (Process |
| | | # 20) |

### Another Updated Proposed Table

Process #2: MESH_NORMAL_DELTA
Process #1: MESH_NORMAL_MPARA
Process #23: MESH_NORMAL_CROSS

These are also explained in the section before. The updated table is shown ahead:

TABLE I-10
Mesh attribute prediction methods for
MESH_ATTR_NORMAL type attributes

| mesh_attribute_{—} | | |
|---|---|---|
| prediction_{—} | | Prediction |
| method[ i ] | Identifier | Method |
| 0 | MESH_NORMAL_DELTA | Delta |
| | | (Process # 2) |
| 1 | MESH_NORMAL_MPARA | Multi-parallelogram |
| | | (Process # 1) |
| 2 | MESH_NORMAL_CROSS | Cross product |
| | | (Process # 23) |

Changes/Flexibility to the Framework—The following changes/flexibility can be added to this framework:

In the current implementation (TMM v6.0) of static mesh encoder that employs the EdgeBreaker, the connectivity is decoded first and then for each vertex, the attributes (geometry, UV coordinates) of the vertex are decoded. However, the system may have more flexibility and therefore better results by either serializing or parallelizing the attribute encoding process. V-DMC decoder 300 may (1) decode one attribute at a time for all vertices before going to the next attribute or (2) decode all the attributes for one vertex before moving to the next vertex. The possible advantages of the first process (1) would be to give us better compression performance. The possible advantages of the second process (2) would be to give us parallelism in computing and better hardware implementation that could potentially improve the encoding/decoding time.

In TMM v7.0, the attributes are decoded in a serial manner. First the topology is decoded, then each attribute is decoded one after another. This is described above.

Rather than using a single normal prediction process, V-DMC decoder 300 may employ multiple normal prediction processes and devise a process to predict which normal prediction process is being used at the decoder.

We could also further transmit additional bits to inform the decoder on which normal prediction process is being employed. This could give the flexibility of having multiple normal prediction processes in the software and using the one that is best for the current sequence, current mesh, current sub mesh, current connected component, or some other cluster of vertices.

The encoder-decoder architecture of this disclosure may include quantization and dequantization. The techniques may further include quantization refinement for normal encoding. Aspects of quantization refinement are explained in Jun Tian, Xiaozhong Xu, Shan Liu (Tencent) “[V-DMC] [EE4.4] Report on base mesh quantization refinement”, ISO/IEC JTC1/SC29/WG7, m66074, Online, January 2024, which is hereby incorporated by reference.

Please note that the cross-product based normal estimation can be in either direction. V-DMC decoder 300 may have a signal/parameter received from V-DMC encoder 200 to signal the direction of the normal. This signal may be sequence level, frame level, sub mesh level, connected-component-level, cluster of vertice/triangle level, or even just a vertex level (one for each vertex). V-DMC decoder 300 may also predict the direction of the normal from the previously encoded/decoded normal.

Aspect of the signaling and framework functionality will now be described. For the normal prediction itself, there is typically no additional information needed to be sent to the decoder side. However, flexibility may be added to the system that could involve adding additional overhead and a need to transmit additional signaling bits.

This signaling can happen on the sequence level, frame level, sub mesh level, connected component level, any other smaller cluster of vertices, or even per vertex level.

The extra signals that V-DMC decoder 300 could send to V-DMC decoder 300 may include:
A signal to tell which normal prediction to use.
A signal to tell on what level the prediction is being applied.
If there are multiple types of predictions, then V-DMC encoder 200 may signal which prediction was applied to which part of the data. A signal to tell which direction to the surface the normal is facing. The perpendicular/normal to the surface could be in two directions. However, the normal would only be facing in one direction. To predict normal, it could potentially help to signal this direction.

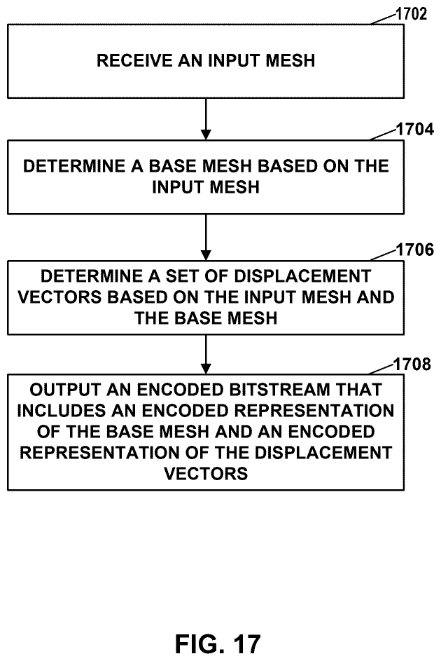

FIG. 17 is a flowchart illustrating an example process for encoding a mesh. Although described with respect to V-DMC encoder 200 (FIGS. 1 and 2), it should be understood that other devices may be configured to perform a process similar to that of FIG. 17.

In the example of FIG. 17, V-DMC encoder 200 receives an input mesh (1702). V-DMC encoder 200 determines a base mesh based on the input mesh (1704). V-DMC encoder 200 determines a set of displacement vectors based on the input mesh and the base mesh (1706). V-DMC encoder 200 outputs an encoded bitstream that includes an encoded representation of the base mesh and an encoded representation of the displacement vectors (1708). V-DMC encoder 200 may additionally determine attribute values from the input mesh and include an encoded representation of the attribute values vectors in the encoded bitstream.

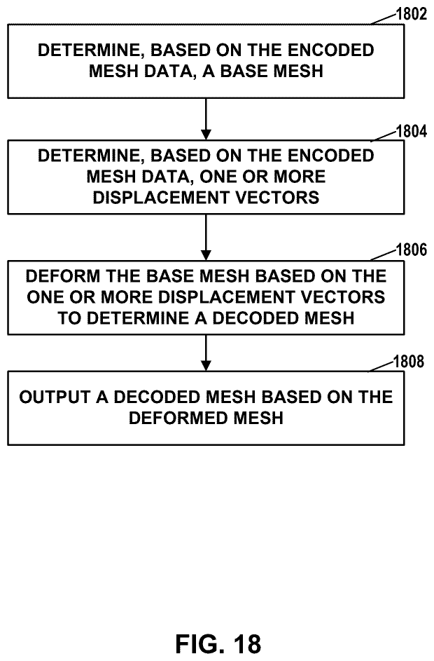

FIG. 18 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 18.

In the example of FIG. 18, V-DMC decoder 300 determines, based on the encoded mesh data, a base mesh (1802). V-DMC decoder 300 determines, based on the encoded mesh data, one or more displacement vectors (1804). V-DMC decoder 300 deforms the base mesh using the one or more displacement vectors (1806). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1808). V-DMC decoder 300 may, for example, output the decoded mesh for storage, transmission, or display.

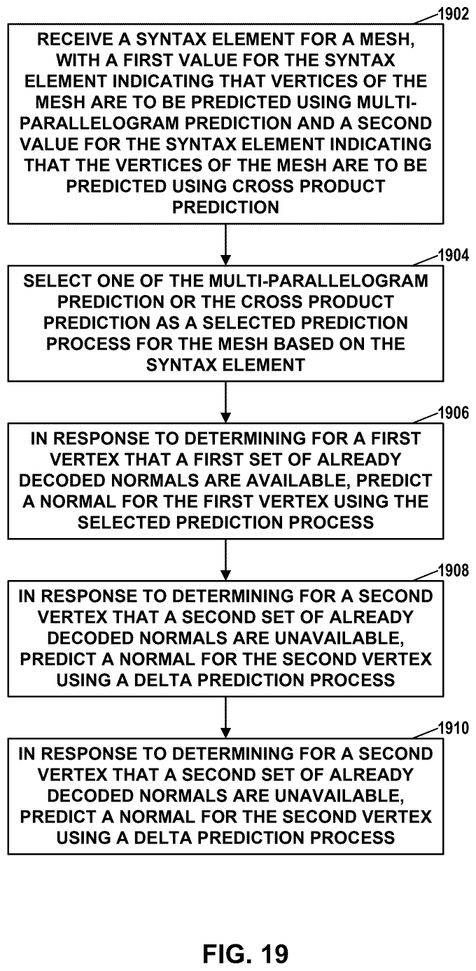

FIG. 19 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 19.

V-DMC decoder 300 receives a syntax element for a mesh, with a first value for the syntax element indicating that vertices of the mesh are to be predicted using multi-parallelogram prediction and a second value for the syntax element indicating that the vertices of the mesh are to be predicted using cross product prediction (1902).

V-DMC decoder 300 selects one of the multi-parallelogram prediction or the cross product prediction as a selected prediction process for the mesh based on the syntax element (1904). In response to determining for a first vertex that a first set of already decoded normals are available, V-DMC decoder 300 predicts a normal for the first vertex using the selected prediction process (1906). If the selected prediction process is multi-parallelogram prediction, then to predict the normal for the first vertex using the selected prediction process, V-DMC decoder 300 may be configured to determine a predicted normal value for the first vertex based on a previous normal value plus a next normal value minus an opposite normal value. If the selected prediction process is cross product prediction, then to predict the normal for the first vertex using the selected prediction process, V-DMC decoder 300 may be configured to determine a first vector between a previous vertex and the first vertex; determine a second vector between a next vertex and the first vertex; and determine a cross product of the first vector and the second vector.

In response to determining for a second vertex that a second set of already decoded normals are unavailable, V-DMC decoder 300 predicts a normal for the second vertex using a delta prediction process (1908). To predict the normal for the second vertex using the delta prediction process, V-DMC decoder 300 may be configured to identify a single vertex on a same triangle as the second vertex; set a predicted normal value for the second vertex to be equal to a vertex value of a normal for the single vertex; receive a difference value; and add the difference value to the predicted normal value for the second vertex to determine the normal for the second vertex.

V-DMC decoder 300 outputs a decoded version of the mesh based on the normal for the first vertex and the normal for the second vertex (1910). The normal for the first vertex may, for example, be a first vector perpendicular to the decoded version of the mesh at the first vertex, and the normal for the second vertex may be a second vector perpendicular to the decoded version of the mesh at the second vertex.

The following numbered clauses illustrate one or more aspects of the devices and techniques described in this disclosure.

Clause 1. A device for processing mesh data, the device comprising: a memory; and processing circuitry coupled to the memory and configured to: receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; select one of the multi-parallelogram prediction or the cross product prediction as a selected prediction process for the mesh based on the syntax element; in response to determining for a first vertex that a first set of already decoded normals are available, predict a normal for the first vertex using the selected prediction process; in response to determining for a second vertex that a second set of already decoded normals are unavailable, predict a normal for the second vertex using a delta prediction process; and output a decoded version of the mesh based on the normal for the first vertex and the normal for the second vertex.

Clause 2. The device of clause 1, wherein to predict the normal for the second vertex using the delta prediction process, the processing circuitry is configured to: identify a single vertex on a same triangle as the second vertex; set a predicted normal value for the second vertex to be equal to a vertex value of a normal for the single vertex; receive a difference value; and add the difference value to the predicted normal value for the second vertex to determine the normal for the second vertex.

Clause 3. The device of clause 1, wherein the selected prediction process comprises multi-parallelogram prediction and wherein to predict the normal for the first vertex using the selected prediction process, the processing circuitry is configured to: determine a predicted normal value for the first vertex based on a previous normal value plus a next normal value minus an opposite normal value.

Clause 4. The device of clause 1, wherein the selected prediction process comprises cross product prediction and wherein predicting the normal for the first vertex using the selected prediction process, the processing circuitry is configured to: determine a first vector between a previous vertex and the first vertex; determine a second vector between a next vertex and the first vertex; and determine a cross product of the first vector and the second vector.

Clause 5. The device of clause 1, further comprising: in response to determining for a third vertex that a third set of already decoded normals are unavailable, receive a full normal value for the third vertex in the mesh data.

Clause 6. The device of clause 1, wherein the normal for the first vertex comprises a first vector perpendicular to the decoded version of the mesh at the first vertex and the normal for the second vertex comprises a second vector perpendicular to the decoded version of the mesh at the second vertex.

Clause 7. The device of clause 1, wherein the normal for the first vertex and the normal for the second vertex are losslessly encoded.

Clause 8. The device of clause 1, further comprising a display to present imagery based on the decoded version of the mesh.

Clause 9. A method of processing mesh data, the method comprising: receiving a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; selecting one of the multi-parallelogram prediction or the cross product prediction as a selected prediction process for the mesh based on the syntax element; in response to determining for a first vertex that a first set of already decoded normals are available, predicting a normal for the first vertex using the selected prediction process; in response to determining for a second vertex that a second set of already decoded normals are unavailable, predicting a normal for the second vertex using a delta prediction process; and outputting a decoded version of the mesh based on the normal for the first vertex and the normal for the second vertex.

Clause 10. The method of clause 9, wherein predicting the normal for the second vertex using the delta prediction process comprises: identifying a single vertex on a same triangle as the second vertex; setting a predicted normal value for the second vertex to be equal to a vertex value of a normal for the single vertex; receiving a difference value; and adding the difference value to the predicted normal value for the second vertex to determine the normal for the second vertex.

Clause 11. The method of clause 9, wherein the selected prediction process comprises multi-parallelogram prediction and wherein predicting the normal for the first vertex using the selected prediction process comprises: determining a predicted normal value for the first vertex based on a previous normal value plus a next normal value minus an opposite normal value.

Clause 12. The method of clause 9, wherein the selected prediction process comprises cross product prediction and wherein predicting the normal for the first vertex using the selected prediction process comprises: determining a first vector between a previous vertex and the first vertex; determining a second vector between a next vertex and the first vertex; and determining a cross product of the first vector and the second vector.

Clause 13. The method of clause 9, further comprising: in response to determining for a third vertex that a third set of already decoded normals are unavailable, receiving a full normal value for the third vertex in the mesh data.

Clause 14. The method of clause 9, wherein the normal for the first vertex comprises a first vector perpendicular to the decoded version of the mesh at the first vertex and the normal for the second vertex comprises a second vector perpendicular to the decoded version of the mesh at the second vertex.

Clause 15. The method of clause 9, wherein the normal for the first vertex and the normal for the second vertex are losslessly encoded.

Clause 16. A computer-readable storage medium having stored thereon instructions that, when executed, cause one or more processors to receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction; select one of the multi-parallelogram prediction or the cross product prediction as a selected prediction process for the mesh based on the syntax element; in response to determining for a first vertex that a first set of already decoded normals are available, predict a normal for the first vertex using the selected prediction process; in response to determining for a second vertex that a second set of already decoded normals are unavailable, predict a normal for the second vertex using a delta prediction process; and output a decoded version of the mesh based on the normal for the first vertex and the normal for the second vertex.

Clause 17. The computer-readable storage medium of clause 16, wherein to predict the normal for the second vertex using the delta prediction process, the one or more processors are configured to: identify a single vertex on a same triangle as the second vertex; set a predicted normal value for the second vertex to be equal to a vertex value of a normal for the single vertex; receive a difference value; and add the difference value to the predicted normal value for the second vertex to determine the normal for the second vertex.

Clause 18. The computer-readable storage medium of clause 16, wherein the selected prediction process comprises multi-parallelogram prediction and wherein to predict the normal for the first vertex using the selected prediction process, the one or more processors are configured to: determine a predicted normal value for the first vertex based on a previous normal value plus a next normal value minus an opposite normal value.

Clause 19. The computer-readable storage medium of clause 16, wherein the selected prediction process comprises cross product prediction and wherein predicting the normal for the first vertex using the selected prediction process, the one or more processors are configured to: determine a first vector between a previous vertex and the first vertex; determine a second vector between a next vertex and the first vertex; and determine a cross product of the first vector and the second vector.

Clause 20. The computer-readable storage medium of clause 16, further comprising: in response to determining for a third vertex that a third set of already decoded normals are unavailable, receive a full normal value for the third vertex.

Clause 21. A method of processing mesh data, the method comprising: any technique or combination of techniques described in this disclosure.

Clause 22. The method of any of clause 21, further comprising generating the mesh data.

Clause 23. A device for processing mesh data, the device comprising: a memory configured to store the mesh data; and one or more processors coupled to the memory, implemented in circuitry, and configured to perform any technique or combination of techniques described in this disclosure.

Clause 24. The device clause 23, wherein the device comprises a decoder.

Clause 25. The device of clause 23, wherein the device comprises an encoder.

Clause 26. The device of any of clauses 23-24, further comprising a device to generate the mesh data.

Clause 27. The device of any of clauses 23-26, further comprising a display to present imagery based on the mesh data.

Clause 28. A computer-readable storage medium having stored thereon instructions that, when executed, cause one or more processors to perform any technique or combination of techniques described in this disclosure.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for processing mesh data, the device comprising:
a memory; and
processing circuitry coupled to the memory and configured to:
receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction;
select one of the multi-parallelogram prediction or the cross product prediction as a selected prediction process for the mesh based on the syntax element;
in response to determining for a first vertex that a first set of already decoded normals are available, predict a normal for the first vertex using the selected prediction process;
in response to determining for a second vertex that a second set of already decoded normals are unavailable, predict a normal for the second vertex using a delta prediction process; and
output a decoded version of the mesh based on the normal for the first vertex and the normal for the second vertex.

2. The device of claim 1, wherein to predict the normal for the second vertex using the delta prediction process, the processing circuitry is configured to:
identify a single vertex on a same triangle as the second vertex;
set a predicted normal value for the second vertex to be equal to a vertex value of a normal for the single vertex;
receive a difference value; and
add the difference value to the predicted normal value for the second vertex to determine the normal for the second vertex.

3. The device of claim 1, wherein the selected prediction process comprises multi-parallelogram prediction and wherein to predict the normal for the first vertex using the selected prediction process, the processing circuitry is configured to:
determine a predicted normal value for the first vertex based on a previous normal value plus a next normal value minus an opposite normal value.

4. The device of claim 1, wherein the selected prediction process comprises cross product prediction and wherein predicting the normal for the first vertex using the selected prediction process, the processing circuitry is configured to:
determine a first vector between a previous vertex and the first vertex;
determine a second vector between a next vertex and the first vertex; and
determine a cross product of the first vector and the second vector.

5. The device of claim 1, further comprising:
in response to determining for a third vertex that a third set of already decoded normals are unavailable, receive a full normal value for the third vertex in the mesh data.

6. The device of claim 1, wherein the normal for the first vertex comprises a first vector perpendicular to the decoded version of the mesh at the first vertex and the normal for the second vertex comprises a second vector perpendicular to the decoded version of the mesh at the second vertex.

7. The device of claim 1, wherein the normal for the first vertex and the normal for the second vertex are losslessly encoded.

8. The device of claim 1, further comprising a display to present imagery based on the decoded version of the mesh.

9. A method of processing mesh data, the method comprising:
receiving a syntax element for a mesh, wherein a first value for the syntax element indicates that vertices of the mesh are to be predicted using multi-parallelogram prediction and a second value for the syntax element indicates that the vertices of the mesh are to be predicted using cross product prediction;
selecting one of the multi-parallelogram prediction or the cross product prediction as a selected prediction process for the mesh based on the syntax element;
in response to determining for a first vertex that a first set of already decoded normals are available, predicting a normal for the first vertex using the selected prediction process;
in response to determining for a second vertex that a second set of already decoded normals are unavailable, predicting a normal for the second vertex using a delta prediction process; and
outputting a decoded version of the mesh based on the normal for the first vertex and the normal for the second vertex.

10. The method of claim 9, wherein predicting the normal for the second vertex using the delta prediction process comprises:
identifying a single vertex on a same triangle as the second vertex;
setting a predicted normal value for the second vertex to be equal to a vertex value of a normal for the single vertex;
receiving a difference value; and
adding the difference value to the predicted normal value for the second vertex to determine the normal for the second vertex.

11. The method of claim 9, wherein the selected prediction process comprises multi-parallelogram prediction and wherein predicting the normal for the first vertex using the selected prediction process comprises:
determining a predicted normal value for the first vertex based on a previous normal value plus a next normal value minus an opposite normal value.

12. The method of claim 9, wherein the selected prediction process comprises cross product prediction and wherein predicting the normal for the first vertex using the selected prediction process comprises:
determining a first vector between a previous vertex and the first vertex;
determining a second vector between a next vertex and the first vertex; and
determining a cross product of the first vector and the second vector.

13. The method of claim 9, further comprising:
in response to determining for a third vertex that a third set of already decoded normals are unavailable, receiving a full normal value for the third vertex in the mesh data.

14. The method of claim 9, wherein the normal for the first vertex comprises a first vector perpendicular to the decoded version of the mesh at the first vertex and the normal for the second vertex comprises a second vector perpendicular to the decoded version of the mesh at the second vertex.

15. The method of claim 9, wherein the normal for the first vertex and the normal for the second vertex are losslessly encoded.

16. A computer-readable storage medium having stored thereon instructions that, when executed, cause one or more processors to:
receive a syntax element for a mesh, wherein a first value for the syntax element indicates that vertices of the mesh are to be predicted using multi-parallelogram prediction and a second value for the syntax element indicates that the vertices of the mesh are to be predicted using cross product prediction;
select one of the multi-parallelogram prediction or the cross product prediction as a selected prediction process for the mesh based on the syntax element;
in response to determining for a first vertex that a first set of already decoded normals are available, predict a normal for the first vertex using the selected prediction process;
in response to determining for a second vertex that a second set of already decoded normals are unavailable, predict a normal for the second vertex using a delta prediction process; and
output a decoded version of the mesh based on the normal for the first vertex and the normal for the second vertex.

17. The computer-readable storage medium of claim 16, wherein to predict the normal for the second vertex using the delta prediction process, the one or more processors are configured to:
identify a single vertex on a same triangle as the second vertex;
set a predicted normal value for the second vertex to be equal to a vertex value of a normal for the single vertex;
receive a difference value; and
add the difference value to the predicted normal value for the second vertex to determine the normal for the second vertex.

18. The computer-readable storage medium of claim 16, wherein the selected prediction process comprises multi-parallelogram prediction and wherein to predict the normal for the first vertex using the selected prediction process, the one or more processors are configured to:
determine a predicted normal value for the first vertex based on a previous normal value plus a next normal value minus an opposite normal value.

19. The computer-readable storage medium of claim 16, wherein the selected prediction process comprises cross product prediction and wherein predicting the normal for the first vertex using the selected prediction process, the one or more processors are configured to:
determine a first vector between a previous vertex and the first vertex;
determine a second vector between a next vertex and the first vertex; and
determine a cross product of the first vector and the second vector.

20. The computer-readable storage medium of claim 16, further comprising:
in response to determining for a third vertex that a third set of already decoded normals are unavailable, receive a full normal value for the third vertex.
